(19) United States
(12) Patent Application Publication
(10) Pub. No.: US 2025/0023333 A1
(43) Pub. Date: Jan. 16, 2025

(54) POWER SUPPLY MODULE

(71) Applicant: Wöhner Besitz GmbH, Rödental (DE)

(72) Inventors: Philipp Steinberger, Coburg (DE); Joram Masel, Küps (DE); Florian Höfner, Rödental (DE)

(21) Appl. No.: 18/712,473

(22) PCT Filed: Nov. 14, 2022
(86) PCT No.: PCT/EP2022/081854

§ 371 Date: May 22, 2024

(30) Foreign Application Priority Data
Nov. 22, 2021 (EP) 21209632.5

(51) Int. Cl. H02B 1/20; H02B 1/32

(52) U.S. Cl. CPC H02B 1/20; H02B 1/32

(57) ABSTRACT

A power supply module for rear-side power supply of a power distribution busbar system comprising a number of busbars for distribution of electrical power for busbar components connectable to said busbars, said rear side power supply module comprising at least one clamping block having a number of clamping contacts adapted to clamp electrical conductors to said clamping block and comprising a number of electrically conductive and touch-protected intermediate bars provided between the at least one clamping block and a number of touch-protected electrical contacts provided at a front side of said power supply module and adapted to establish an electrical connection between the busbars of said power distribution busbar system and the intermediate bars of said power supply module.

### FIELD OF THE INVENTION

The invention relates to a power supply module for providing a rear-side power supply of a power distribution busbar system which can be mounted in a control cabinet.

### TECHNICAL BACKGROUND

A control cabinet can comprise a power distribution system to distribute electrical power among electrical devices mounted in the control cabinet. Control cabinets can be used to accommodate switch gear and switching elements, such as contactors, fuse elements or display units which can for example indicated the operating states of downstream power-consuming entities. A control cabinet can comprise a power distribution busbar system comprising busbars for distribution of electrical power between different busbar components of the control cabinet. These busbar components comprise for instance motor starter, switch disconnectors or circuit breakers. The internal power distribution busbar system of the control cabinet can be connected to external conductors to receive electrical power supply from a power supply network. During assembly of busbar components to the busbars of the power distribution busbar system, safety requirements to provide safety for a user have to be fulfilled.

In a conventional control cabinet the power feed-in of electrical supply power is performed by means of a power supply module placed on a front side of the busbar. This has the disadvantage that the space required for this front side power supply module is lost for other busbar components.

### SUMMARY OF THE INVENTION

Accordingly, it is an object of the present invention to provide a power supply module which does makes a more efficient use of the available space within a control cabinet.

It is a further object of the present invention to provide a power supply module which can be easily installed in a control cabinet and which provides safety for a user when handling busbar components of the control cabinet.

These objects are achieved by a power supply module comprising the features of claim 1.

The invention provides according to a first aspect a power supply module for rear-side power supply of a power distribution busbar system comprising a number, N, of busbars for distribution of electrical power for busbar components connectable to said busbars, said rear side power supply module comprising:
at least one clamping block having a number, N, of clamping contacts adapted to clamp electrical conductors to said clamping block; and
a number, N, of electrically conductive and touch protected intermediate bars provided between the at least one clamping block and a number, N, of touch-protected electrical contacts provided at a front side of said power supply module and adapted to establish an electrical connection between the busbars of said power distribution busbar system and the intermediate bars of said power supply module.

A significant advantage of the power supply module according to the first aspect of the present invention is that by the special power supply feed-in of electrical power from behind the busbars the space on the front side of the busbars can be fully used to place other busbar components on the power distribution busbar system and to make in this way a very efficient use of the available mounting space within the control cabinet.

A further advantage of the power supply module according to the first aspect of the present invention is that it can be mounted onto the power distribution busbar system without a tool.

A still further advantage is that the mechanical fixation of the power supply module to the busbars and an electrical contacting of the busbars takes place simultaneously.

In a possible embodiment the rear side power supply module comprises
a first clamping block having a number of clamping contacts adapted to clamp electrical conductors to said first clamping block,
a second clamping block having a number of clamping contacts adapted to clamp electrical conductors to said second clamping block,
a number of intermediate bars provided between said first clamping block and said second clamping block to provide electrical connection between the electrical conductors clamped to the first clamping block and the electrical clamping contacts of the second clamping block and
a number of touch-protected electrical contacts provided at a front side of said power supply module and adapted to establish an electrical connection between the busbars of the power distribution busbar system and the intermediate bars of said power supply module.

The provision of two clamping blocks at opposite sides of the rear side power supply module has the advantage that a chain of serially connected power supply modules can be formed including a number of power supply modules which are adapted to provide electrical power supply to a corresponding number of power supply busbar sets or busbar boards.

This facilitates also a flexible adaption of the size of the power distribution system for the respective use case.

The power supply module according to the first aspect of the present invention provides the advantage that busbar components of the power distribution busbar system can also be mounted on the front side of the power supply module thus making efficient use of the available space within the control cabinet.

Further, an advantage of the power supply module is that it provides touch protection for a user performing maintenance or repair services at the control cabinet.

A still further advantage of the power supply module according to the first aspect of the present invention resides in that the mounting of busbar components on the power distribution busbar system can be easily performed by a user from a front side of the control cabinet without interference with the continuous power supply of the power distribution busbar system through the power supply module according to the first aspect of the present invention.

In a possible embodiment of the power supply module according to the first aspect of the present invention, the touch protected electrical contacts of the power supply module comprise electrical lyre or U-shaped contacts each having a base contact portion connecting two opposing leg contact portions of the respective electrical lyre or U-shaped contact with each other.

In a further possible embodiment of the power supply module according to the first aspect of the present invention, the base contact portion of the electrical lyre or U-shaped contact is electrically connected to an associated intermediate bar of said power supply module.

In a further possible embodiment of the power supply module according to the first aspect of the present invention, the two leg contact portions of the electrical lyre or U-shaped contact are touch protected by electrically isolating cover portions of the housing front side to provide finger-safe (IP20) touch protection of the leg contact portions of the electrical lyre or U-shaped contact, wherein the housing front side is further adapted to cover the associated intermediate bar lying beneath the housing front side.

In a still further possible embodiment of the power supply module according to the first aspect of the present invention, the two leg contact portions of an electrical lyre or U-shaped contact can comprise electrical contact surfaces facing each other, wherein the remaining surface of each leg contact portion is coated with an electrically isolating material to provide finger-safe (IP20) touch protection of the leg contact portions of the electrical lyre or U-shaped contact.

In a still further possible embodiment of the power supply module according to the first aspect of the present invention, a portion of a busbar of the power distribution busbar system is pluggable between the electrical contact surfaces of the two leg contact portions of the electrical lyre or U-shaped contact to establish an electrical connection between the busbar of the power distribution busbar system and an intermediate bar of said power supply module through said electrical lyre or U-shaped contact.

In a still further possible embodiment of the power supply module according to the first aspect of the present invention, the two leg contact portions of the electrical lyre or U-shaped contact facing each other and encompassing a portion of a busbar of said power distribution busbar system are attracted to each other in response to an electrical overcurrent flowing through the electrical lyre or U-shaped contact and are pressed against the encompassed portion of the busbar to prevent a separation of the busbar from the electrical lyre or U-shaped contact of the power supply module and/or to prevent an electrical arc.

Accordingly, the electrical lyre or U-shaped contact being pressed in reaction to an electrical overcurrent like a short circuit current against the encompassed portion of the busbar prevents a lift-off of the busbar and also prevents an electrical arc during an overcurrent event thus increasing operation safety of the power distribution busbar system of the control cabinet.

The lyre shape of the electrical contact leads to a self-amplifying effect during an overcurrent event.

In a still further possible embodiment of the power supply module according to the first aspect of the present invention, the busbar of the power distribution system has a U-shaped profile with two opposing busbar sidewalls connected by a busbar base portion of the busbar.

In a still further possible embodiment of the power supply module according to the first aspect of the present invention, a sidewall of said U-shaped busbar is pluggable between the electrical contact surfaces of the two leg contact portions of the respective electrical lyre or U-shaped contact to establish an electrical connection between the U-shaped d busbar and the intermediate bar through the electrical lyre or U-shaped contact.

In a further possible embodiment of the power supply module according to the first aspect of the present invention, the busbar base portion of the U-shaped busbar of said power distribution busbar system does comprise contact slots adapted to receive protruding electrical contacts of busbar components pluggable into the contact slots of the busbar base portion of said U-shaped busbar.

In a further possible embodiment of the power supply module according to the first aspect of the present invention, the first clamping block and the second clamping block of the power supply module are both touch-protected by associated removable or moveable touch protection cover elements.

In a still further possible embodiment of the power supply module according to the first aspect of the present invention, the removable touch protection cover element of a clamping block is secured by a sealing element or by a lock element against unintentional removal of the touch protection cover element by a user.

In a still further possible embodiment of the power supply module according to the first aspect of the present invention, the clamping contacts of a clamping block comprise prism clamps.

In a further possible embodiment of the power supply module according to the first aspect of the present invention, the clamping contacts of a clamping block comprise box terminal clamps.

In a further possible embodiment of the power supply module according to the first aspect of the present invention, the clamping contacts of the second clamping block of said power supply module provide a loop-through functionality to loop the electrical conductors clamped to the clamping contacts of the first clamping block of said power supply module via intermediate conductors to clamping contacts of a clamping block of an extension power supply module provided for rear-side power supply of further busbars of said power distribution system.

In a possible embodiment the rear side power supply module comprises a single clamping block used for power supply of an associated set of busbars comprising a number, N, of busbars connected to the front-side touch protected contact of the rear side power supply module.

In a further possible embodiment, the rear side power supply comprises two clamping blocks provided on opposite sides of the power supply module and electrically connected to each other via the electrically conductive and touch protected intermediated bars.

In this embodiment several rear side power supply can be serially connected to each other to form a chain of rear side power supply modules each being provided for the power supply of an associated set of busbars mounted to the respective power supply module.

In a further possible embodiment of the power supply module according to the first aspect of the present invention, a busbar board with integrated busbars of the power distribution system is mounted on the power supply module and on an associated auxiliary support module used to provide mechanical support to the mounted busbar board and to provide mechanical tolerance compensation for manufactured screw holes of the power supply module and of its associated auxiliary support module.

In a further possible embodiment of the power supply module according to the first aspect of the present invention, the power supply module, associated extension power supply modules and associated auxiliary support modules are mounted on a mounting platform of a control cabinet.

In a further possible embodiment of the power supply module according to the first aspect of the present invention, the mounting platform of the control cabinet comprises a mounting plate to which the power supply module, the associated extension power supply modules and the auxiliary support modules are fixed.

In a further possible embodiment of the power supply module according to the first aspect of the present invention, the mounting platform of the control cabinet comprises a frame mounted bar system having supporting bars to which a busbar board is fixed by means of corresponding brackets, wherein the power supply module is pluggable into a rear side of the busbar board.

In a still further possible embodiment of the power supply module according to the first aspect of the present invention, the busbars of the power distribution busbar system are integrated in a housing of a touch-protected busbar board.

In a possible embodiment of the power supply module according to the present invention a locking part of the power supply module, of the associated extension power supply module and of the associated auxiliary modules used for a tool-free assembly of the touch-protected busbar board on the respective module is after removal of a touch protection cover element accessible by a tool, in particular by a screw driver, used for disengaging the engaged locking part integrated within the respective modules or provided on the rear side of the housing of the touch-protected busbar board from the assembly element for removal of the touch-protected busbar board from the respective modules in a Z-direction.

In a still further possible embodiment of the power supply module according to the first aspect of the present invention, the locking part of the power supply module, of the associated extension power supply module and of the associated auxiliary modules used for a tool-free assembly of the touch-protected busbar board on the respective module is after removal of a touch protection cover element accessible by a tool used for disengaging the engaging elements integrated in the respective module or provided on the rear side of the housing of the touch-protected busbar board from the assembly element for removal of the touch-protected busbar board from the respective modules.

In a possible embodiment of the power supply module according to the present invention the power supply module is turnable along the z-axis by 180 degrees on the mounting platform such that its clamping block is facing an external power supply.

This is in particular advantageous if only one extension power supply module is used for power feeding of the busbar board. Depending whether the feeding conductors are coming from above or from below within the control cabinet the extension supply module can be turned accordingly.

In a still further possible embodiment of the power supply module according to the first aspect of the present invention, an internal electrical current supply path is provided between a clamping contact of the first clamping block of the power supply module and an associated busbar of the power distribution busbar system through an intermediate bar of said power supply module.

In a further possible embodiment of the power supply module according to the first aspect of the present invention, the power supply module comprises for each internal current supply path a current sensor element adapted to measure an electrical current flowing through the respective current supply path and/or comprises for each internal current supply path a voltage sensor element adapted to measure a voltage applied to the respective current supply path.

In a still further possible embodiment of the power supply module according to the first aspect of the present invention, the internal current supply path of the power supply module comprises a fuse element.

In a still further possible embodiment of the power supply module according to the first aspect of the present invention, the internal current supply path of the power supply module comprises a manually operated or controllable switching element for interruption of the respective internal current supply path of the power supply module to provide protection, in particular overcurrent protection and/or overload protection, to loads receiving their power supplies through busbar components connected to busbars of the power distribution busbar system.

In a further possible embodiment of the power supply module according to the first aspect of the present invention, the controllable switching element comprises a semiconductor power switch controlled by an integrated control unit of said power supply module in response to sensor signals generated by sensor elements of the power supply module.

In a still further possible embodiment of the power supply module according to the first aspect of the present invention, the power supply module comprises a display unit adapted to display a momentary switching state of the integrated switching elements, adapted to display measurement information measured by integrated sensor elements, and/or adapted to display states of integrated fuse elements and/or of connected busbar components and of their loads.

The invention provides according to a further aspect a control cabinet comprising the features of claim 22.

The invention provides according to a second aspect a control cabinet comprising a mounting platform for mounting at least one power supply module according to the first aspect of the present invention used for a rear-side power supply of electrical power to or from a power distribution busbar system of the respective control cabinet.

In a possible embodiment of the control cabinet according to the second aspect of the present invention, the power distribution system comprises a number of busbars used for distribution of AC power or for distribution of DC power among busbar components connected to the busbars of the power distribution system and/or used for powerline communication between busbar components connected to the busbars of the power distribution system.

In a possible embodiment of the control cabinet according to the second aspect of the present invention, the busbar components comprise a motor starter, a switch disconnector, a circuit breaker, a power supply control apparatus and/or an adapter device.

The busbar components form front side busbar components accessible by a user from a front side of the control cabinet.

They can be mounted or assembled directly to busbars or to touch protected busbar boards of the control cabinet without using of tool. The busbar components of the control cabinet can in a possible implementation plugged into slots of busbars or busbar boards having integrated busbars.

In a still further possible embodiment of the control cabinet according to the second aspect of the present invention, a resistive load, a capacitive load or an inductive load is connectable to a busbar component being connected to busbars of the power distribution busbar system of said control cabinet to receive a power supply via the respective busbar component.

### BRIEF DESCRIPTION OF THE DRAWINGS

In the following, possible embodiments of the different aspects of the present invention are described in more detail with reference to the enclosed figures.

FIG. 1 shows a perspective view on a possible embodiment of a power supply module according to the first aspect of the present invention mounted on a mounting plate of a control cabinet;

FIG. 2 shows a further perspective view on a possible embodiment of a power supply module according to the first aspect of the present invention with some touch protection elements blanked out;

FIG. 3 shows a further perspective view on a possible embodiment of a power supply module according to the first aspect of the present invention wherein some parts of the power supply module are removed to illustrate the internal functionality of the power supply module;

FIG. 4 shows a further perspective view on a power supply module according to the first aspect of the present invention with mounted busbars of a power distribution busbar system without some housing elements of the busbar system;

FIGS. 5A to 5F show different views on a possible embodiment of the power supply module according to the first aspect of the present invention in more detail, in particular to illustrate a preferred implementation of touch protected electrical front side contacts of the power supply module;

FIG. 6 shows a perspective view on a power supply module according to the first aspect of the present invention with an associated extension module and associated auxiliary modules mounted on a mounting plate of a control cabinet to which touch-protected busbar boards of the power distribution busbar system are electrically and mechanically connected;

FIG. 7 illustrates the modules mounted on the mounting plate after removal of the touch-protected busbar boards;

FIG. 8 shows a further perspective view on a further alternative exemplary embodiment of a power distribution busbar system where the touch-protected busbar boards are mounted on supporting bars of a frame mounted busbar system;

FIG. 9 illustrates the frame mounted busbar system of FIG. 8 with the power supply module according to the present invention with removed touch-protected busbar boards;

FIG. 10 shows a schematic circuit diagram for illustrating a possible exemplary embodiment of a power supply module according to the first aspect of the present invention;

FIG. 11 shows a further circuit diagram for illustrating a further possible exemplary embodiment of a power supply module according to the first aspect of the present invention;

FIG. 12 shows a perspective view for illustrating a removal of a busbar board from a rear side power supply module and its associated auxiliary support module using a tool;

FIG. 13A, B illustrate a power supply module with contact touch protection elements being sealed or locked to illustrate that in this state the locking part is not accessible;

FIG. 14 illustrates an embodiment where a busbar board is mounted on two main power supply modules having prism clamps;

FIG. 15A, B, C illustrate fixing of conductors to contact elements of a contact block with opened contact touch protection elements;

FIG. 16 illustrates disengaging of a busbar board from a power supply module using a tool and corresponds to FIG. 15C;

FIG. 17A-C illustrate disengaging of a busbar board from an auxiliary support module using a tool;

FIG. 18 shows a further perspective view to illustrate fixing of conductors to contact elements (box terminals) of a contact block with opened contact touch protection elements;

FIG. 19 shows the mounting of busbar components on a busbar board supplied by a power supply module according to the present invention;

FIGS. 20A, 20B illustrate the contacting of a busbar component through a busbar board;

FIGS. 21A, 21B illustrate a tolerance compensation.

### DETAILED DESCRIPTION OF EMBODIMENTS

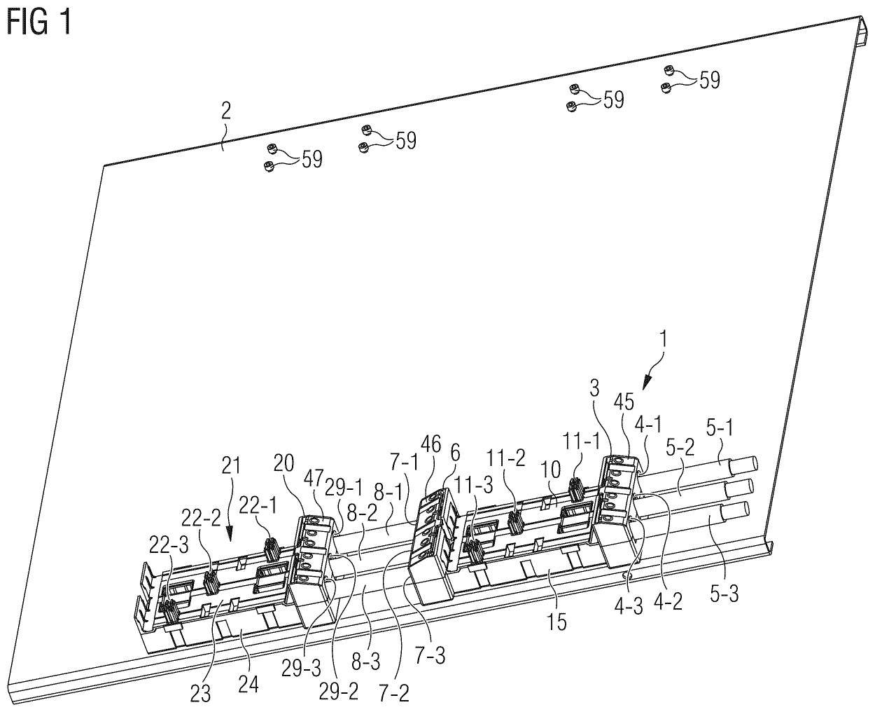

As can be seen from the perspective view illustrated in FIG. 1, a power supply module 1 according to the first aspect of the present invention can be connected to a mounting platform of a control cabinet. In the illustrated embodiment of FIG. 1, the mounting platform of the control cabinet comprises a mounting plate 2 which is provided to mount one or more power supply modules of a power distribution busbar system of the control cabinet. The power distribution busbar system can comprise a number N of busbars 16 used for distribution of electrical power for busbar components connectable to the busbars 16 of the power distribution busbar system. The busbars 16 are integrated in a preferred embodiment in a busbar board 27. In the illustrated embodiment of FIG. 1, the power supply module 1 comprises a first clamping block 3 having a predetermined number N (in FIG. 1 N=3) of clamping contacts 4 adapted to clamp electrical conductors 5 to the first clamping block 3. In the illustrated embodiment of FIG. 1, the first clamping block 3 comprises three clamping contacts 4-1, 4-2, 4-3 adapted to receive a corresponding number N of electrical conductors 5-1, 5-2, 5-3. In the illustrated embodiment of FIG. 1, the electrical conductors 5-i comprise round contactors consisting of an electrically conductive material such as copper or aluminum. The conductors 5-i can also comprise laminated copper bars or similar conducting elements to receive an electrical power supply current from an external power supply source. The clamping contacts 4 of the first clamping block 3 can comprise prism clamp contacts or box terminal contacts or a screw system to fix cables with cable lugs.

The power supply module 1 comprises at least one (first) contact block 3 to receive electrical power. The power supply module 1 comprises in a possible embodiment a second clamping block 6 located on the opposite side of the power supply module 1 as shown in FIG. 1. The second clamping block 6 also comprises a number N of clamping contacts 7-1, 7-2, 7-3 adapted to clamp electrical conductors 8 to the second clamping block 6. In the illustrated embodiment, three electrical conductors 8-1, 8-2, 8-3 can provide an electrical connection of the power supply module 1 to an extension power supply module 21 used for additional busbars. The provision of a second clamping block 6 also allows to form a chain of electrically connected rear side power supply modules 1 wherein the first clamping block 3-i of an i-th power supply module (1-i) is connected to the second clamping block 6-(i−1) of the previous power supply module (1-(i−1)) with in the chain.

The electrical conductors 5, 8 comprise electrically isolating mantles. The electrical conductors 5 can be electrically connected to a local power distribution system of a control cabinet. The power distribution system of the control cabinet comprises a DC power distribution system or comprises an AC power distribution system.

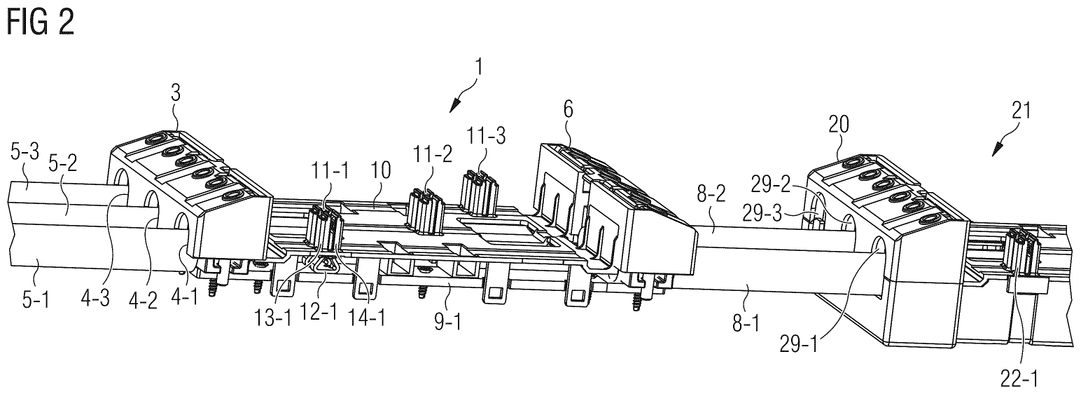

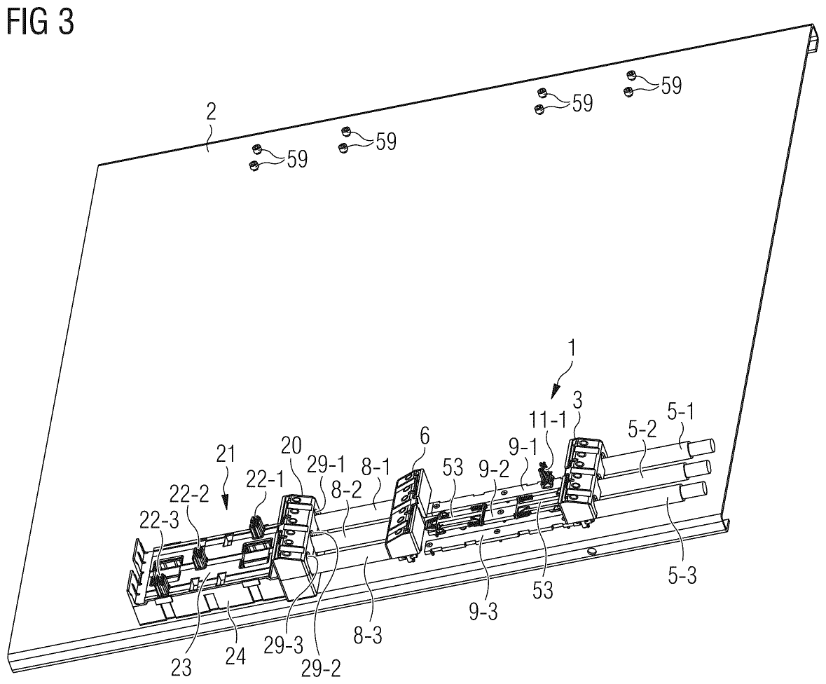

The power supply module 1 further comprises a number N of touch protected intermediate bars 9-1, 9-2, 9-3 provided between the electrical contacts 4-1, 4-2, 4-3 of the first clamping block 3 and the electrical contacts 7-1, 7-2, 7-3 of the second clamping block 6 as shown in FIG. 3. The intermediate bars 9-i are covered on the front side by an isolating housing front side 10 as shown in FIG. 1 and in FIG. 2 and by lateral touch protection cover elements 15. The front side housing front side 10 is removed in FIG. 3. The intermediate bars 9-1, 9-2, 9-3 provided between the first clamping block 3 and the second clamping block 6 provide an electrical connection between the electrical conductors 5-i clamped to the electrical contacts 4-1, 4-2, 4-3 of the first clamping block 3 and the electrical conductors 8-i clamped to the electrical contacts 7-1, 7-2, 7-3 of the second clamping block 6 of the power supply module 1.

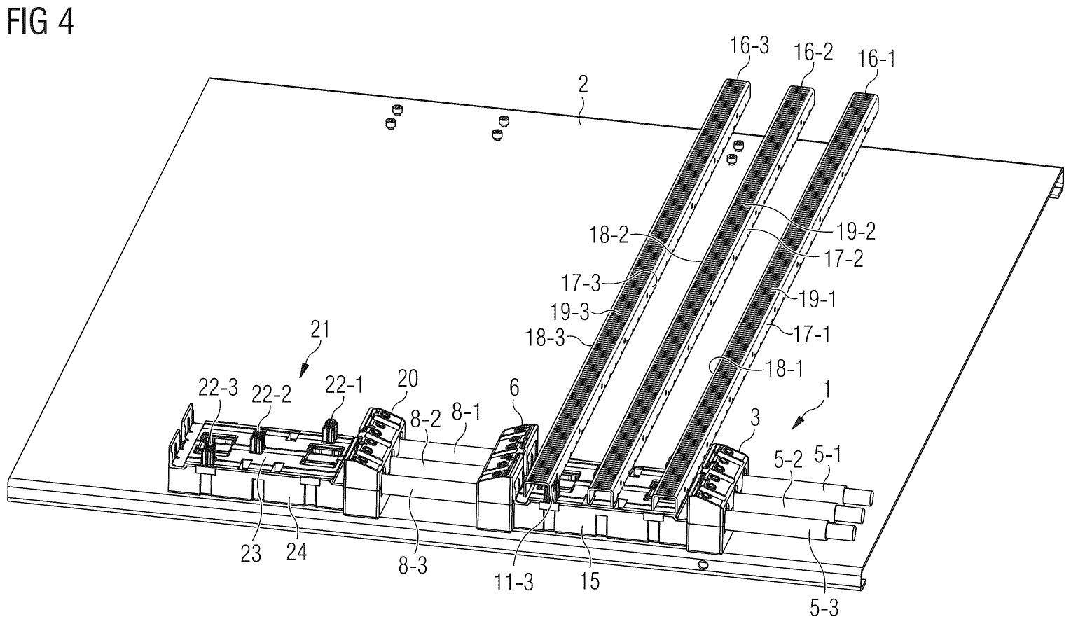

The power supply module 1 further comprises a number N of touch-protected electrical contacts 11-1, 11-2, 11-3 provided at a front side of the power supply module 1 and adapted to establish an electrical connection between busbars such as busbars 16 shown in FIG. 4 of the power distribution busbar system and the intermediate bars 9-1, 9-2, 9-3 of the power supply module 1 covered by the electrically isolating housing front side 10.

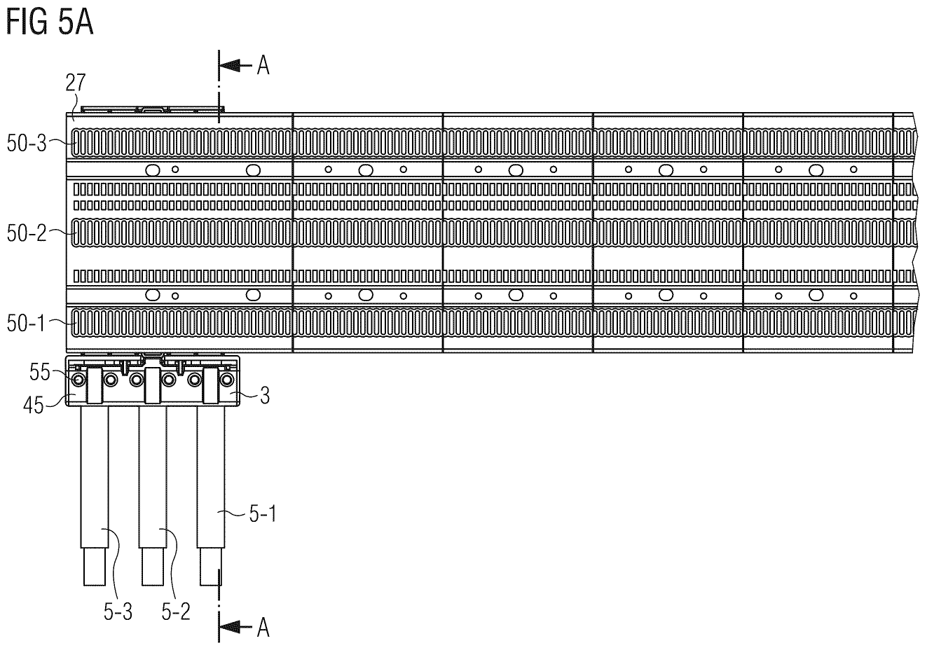

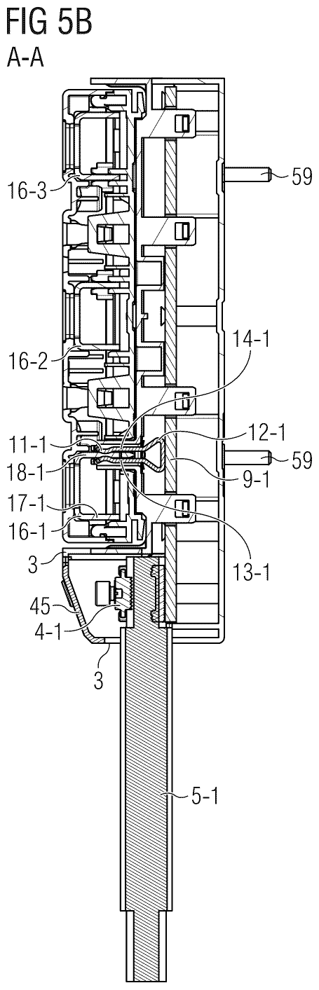

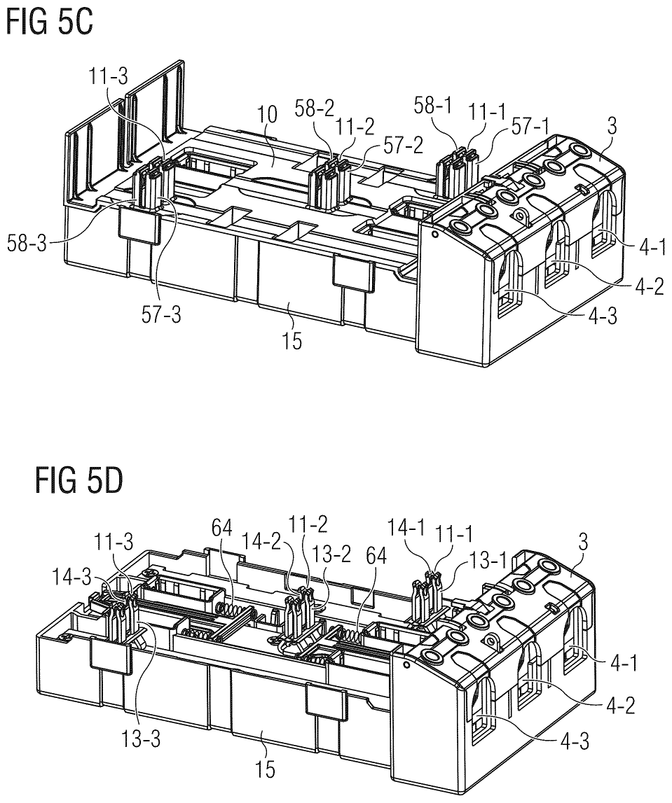

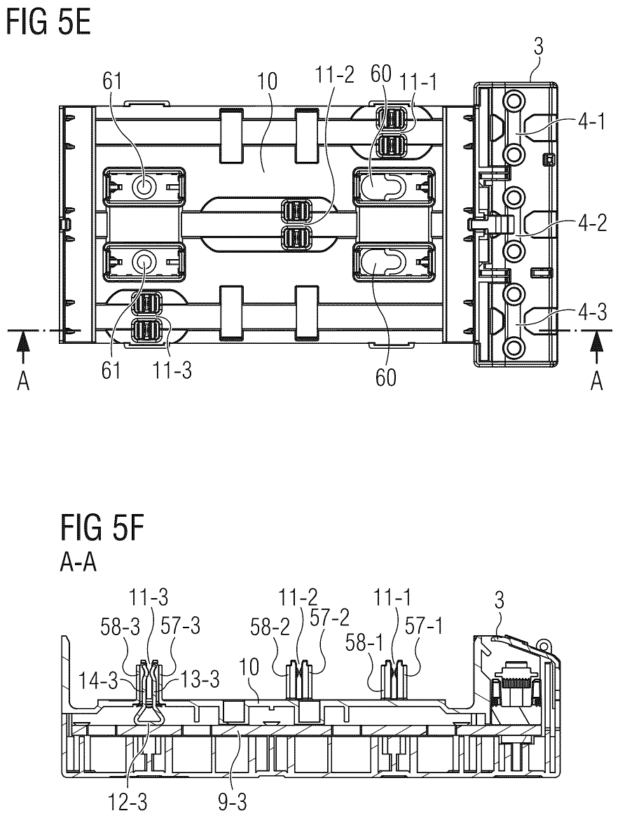

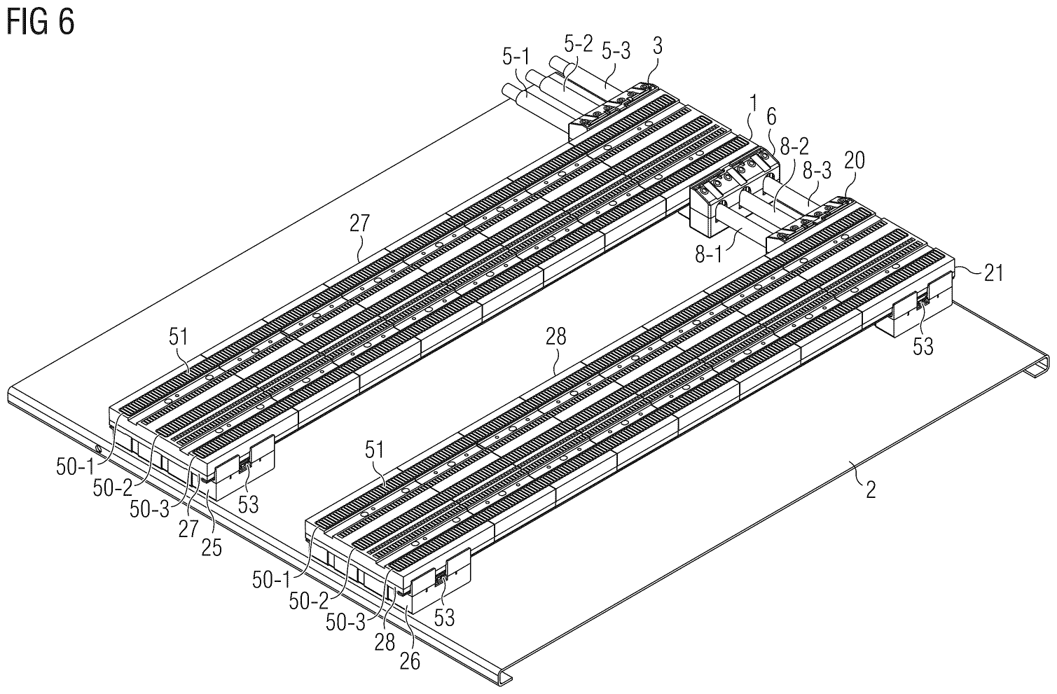

In a preferred embodiment of the power supply module 1 according to the first aspect of the present invention, the touch-protected electrical contacts 11-1, 11-2, 11-3 are also touch protected by the electrically isolating housing front side 10. The touch-protected electrical contacts 11-i comprise in a preferred embodiment electrical lyre or U-shaped contacts 11 having a base contact portion 12-i (visible for the first lyre or U-shaped contact 11-1 in FIG. 2 and visible for the third lyre or U-shaped contact 11-3 in FIG. 5F) connecting two opposing leg contact portions 13-i, 14-i of the respective electrical lyre or U-shaped contact 12-i. In the illustrated embodiment, for each intermediate bar 9-i of the power supply module 1, a pair of electrical lyre or U-shaped contacts 11-i can be provided. The base contact portion 12-i of the electrical lyre or U-shaped contact 11-i is electrically connected to an associated intermediate bar 9-i of the power supply module 1 as shown in FIG. 2 and in FIG. 5F. In FIG. 2, the housing back side 15 of the power supply module 1 as illustrated in FIG. 1 has been removed thus making an internal structure of the power supply module 1 visible. The outer surfaces of the two leg contact portions 13-i, 14-i of each electrical lyre or U-shaped contact 11-i are touch protected by the cover portions 57, 58 of the electrically isolating housing front side 10. The housing front side 10 is provided to cover also the associated intermediate bars 9 lying beneath the housing front side 10 as can be seen in FIG. 5F. This provides a touch protection for a user handling the power supply module 1. Further, the protruding leg contact portions 13-i, 14-i of each electrical lyre or U-shaped contact 11-i comprise electrical contact surfaces facing each other. The remaining surface of each leg contact portion 13-i, 14-i is covered by the protruding portions 57,58 of the housing front side 10 as shown in FIG. 5F or may alternatively be coated with an electrically isolating and heat resistant material to provide finger-safe touch protection of both leg contact portions 13-i, 14-i of each electrical lyre or U-shaped contact 11-i of said power supply module 1. Other kinds of contacts 11-i electrically isolated for a user can be used in alternative embodiments. FIG. 1 and FIG. 3 illustrate also fixing screws 59 used for fixing the power supply modules 1,21 and associated auxiliary support modules 25,26 shown in FIG. 6.

FIG. 4 illustrates the electromechanical connection of three busbars 16-1, 16-2, 16-3 of the power distribution busbar system of the control cabinet to the protruding electrical lyre or U-shaped contacts 11-i of the power supply module 1. A portion of each busbar 16-i of the power distribution busbar system is pluggable between the electrical contact surfaces of the two leg contact portions 13-i, 14-i of each electrical lyre or U-shaped contact 11-i to establish an electrical connection between the respective busbar 16-i of the power distribution busbar system and an intermediate bar 9-i of the power supply module 1 through the electrical lyre or U-shaped contact 11-i.

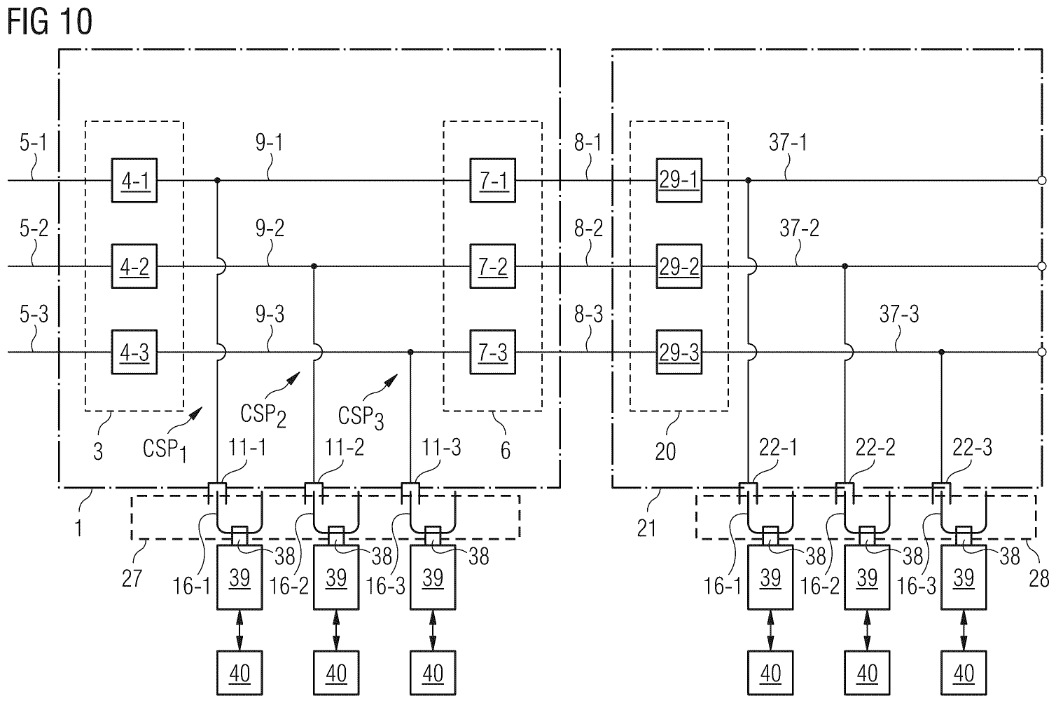

In the illustrated embodiment of FIG. 4, the busbar 16-1, 16-2, 16-3 comprise U-shaped busbars having busbar base portions 19 with contact slots 16A adapted to receive associated electrical contacts 39 of busbar components 40 as shown schematically in FIGS. 10,11.

As can be seen in more detail in the cross-section view of FIG. 5B, a portion of each busbar 16-i can be plugged between electrical contact surfaces of two leg contact portions 13-i, 14-i of an electrical lyre or U-shaped contact 11-i. In the illustrated embodiment of FIG. 4, each busbar 16-i comprises a U-shaped busbar having sidewalls 17-i, 18-i connected through a busbar base portion 19-i of the respective busbar 16-i. The busbar base portion 19 of the U-shaped busbar 16 of the power distribution busbar system comprises a plurality of contact slots 16A adapted to receive protruding electrical contacts 38 of busbar components 39 pluggable into the contact slots 16A of the busbar base portion 19 of the respective U-shaped busbar 16. A sidewall such as the sidewall 17 or the sidewall 18 of each U-shaped busbar can be plugged between the electrical contact surfaces of two leg contact portions 13, 14 of the respective electrical lyre or U-shaped contact 11 to establish an electrical connection between the U-shaped busbar 16 and the intermediate bar 9 covered by the isolating housing front side 10 through the electrical lyre or U-shaped contact 11 of the power supply module 1.

In the cross-section view of FIG. 5B the U-shaped busbar 16-1 comprises two sidewalls 17-1, 18-1, wherein the sidewall 18-1 is plugged between the two leg portions 13-1, 14-1 of the contact 11-1 of the power supply module 1. FIG. 5A shows a front view on a busbar board 27 mounted on a power supply module 1. FIG. 5B is a cross section view along the line A-A shown in FIG. 5A and shows also the fixing screws 59.

FIGS. 5C to 5D are further views to illustrate the touch protected front facing contacts 11-1, 11-2, 11-3 of the power supply module 1. The touch protection of the contacts 11-i is achieved by the electrically isolating housing front side 10 of the power supply module 1 as best visible in the cross-section view of FIG. 5F. FIGS. 5C to 5D show the protruding electrically isolating contact cover portions 57, 58 of
housing front side 10 shown in FIG. 5C which provide touch protection to the corresponding covered leg portions 13, 14 of the front side contacts 11 of the power supply module 1 visible in FIG. 5D where the housing front side 10 is removed.

FIG. 5E shows a front view on the power supply module 1 covered on its front side by the electrically isolating housing front side 10. FIG. 5E shows also a key hole 60 for a fixing screw 59 and a hole 61 for a fixing screw 59.

FIG. 5F is a cross section view along the line A-A in FIG. 5E showing the electrically conductive leg portions 13,14 covered by the corresponding contact cover portions 57,58 of the electrically isolating housing front side 10 of the power supply module 1. The touch protected leg portion 13, 14 are both attached to a common base portion 12 being in electrical contact with the associated intermediate bar 9 of the power supply module 1 as shown in FIG. 5F.

In the embodiment of FIGS. 5A to 5F the power supply module 1 comprises a single clamping block 3 whereas in the embodiment illustrated in FIGS. 1 to 4 the power supply module 1 comprises a first clamping block 3 and a second clamping block 6 located on the opposite side of the first clamping block 3.

In a possible embodiment, the first clamping block 3 and the second clamping block 6 of the power supply module 1 are both touch-protected by associated removable or pivotable touch protection cover elements 45, 46 to get access to the clamping contacts 4, 7 of the respective clamping blocks 3, 6. In a possible embodiment, each removable touch protection cover element 45, 46 of a clamping block 3, 6 of the power supply module 1 can be secured by a sealing element 48 or by a locking element 49 against unintentional removal of the touch protection cover element by a user. The clamping contacts 4, 7 of the clamping blocks 3, 6 can comprise prism clamping contacts. In an alternative implementation, the clamping contacts 4, 7 of the clamping blocks 3, 6 can also comprise box terminal contacts.

In a preferred embodiment of the power supply module 1 according to the first aspect of the present invention, the clamping contacts 7 of the second clamping block 6 provide a loop-through functionality to loop the electrical conductors 5-i clamped to the clamping contacts 4 of the first clamping block 3 of the power supply module 1 via the intermediate bars 9-i and the intermediate conductors 8-i to clamping contacts of a clamping block 20 of an extension power supply module 21 as illustrated in FIGS. 1 to 4. The structure of the extension power supply module 21 is similar to the structure of the main power supply module 1, however, the extension power supply module 21 only comprises in the illustrated embodiment a single clamping block 20 for connection to the main power supply module 1 through the intermediate conductors 8-1, 8-2, 8-3. The extension power supply module 21 also comprises at its front side electrical contacts 22-1, 22-2, 22-3 touch protected by an electrically isolating housing front side 23 for electrical connection of additional busbars of the power distribution busbar system of the control cabinet. The extension power supply module 21 is also provided for rear-side power supply of a busbars of the power distribution busbar system. The extension power supply module 21 comprises electrically isolating sidewalls 24 as shown in FIGS. 1, 3, 4. The contact block 20 of the extension power supply module 21 comprises also a touch protection element 47.

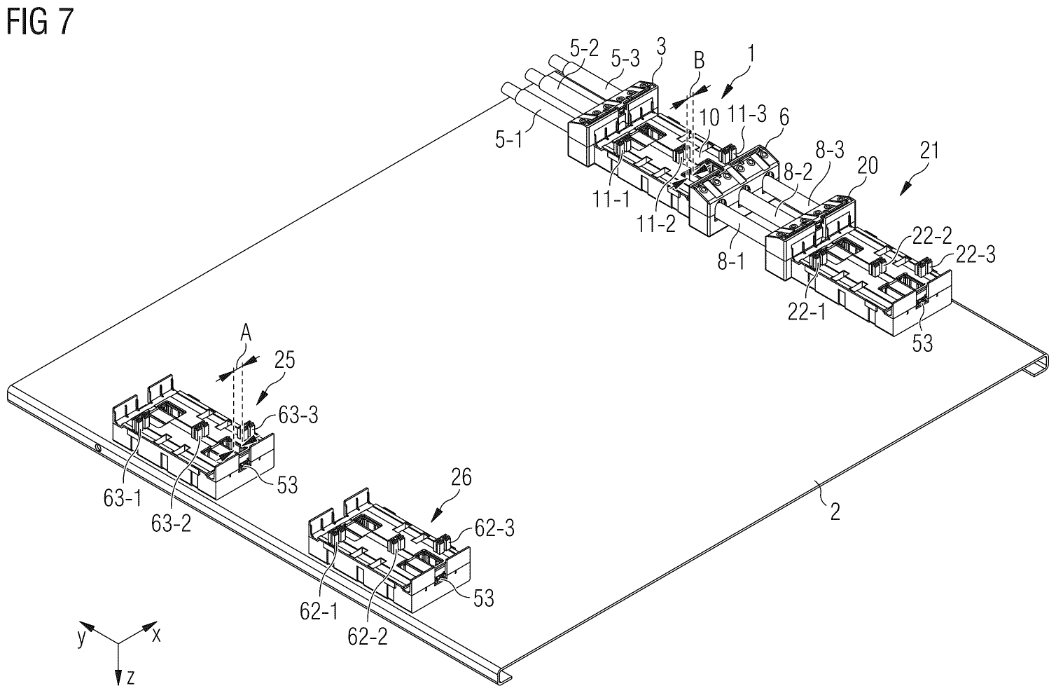

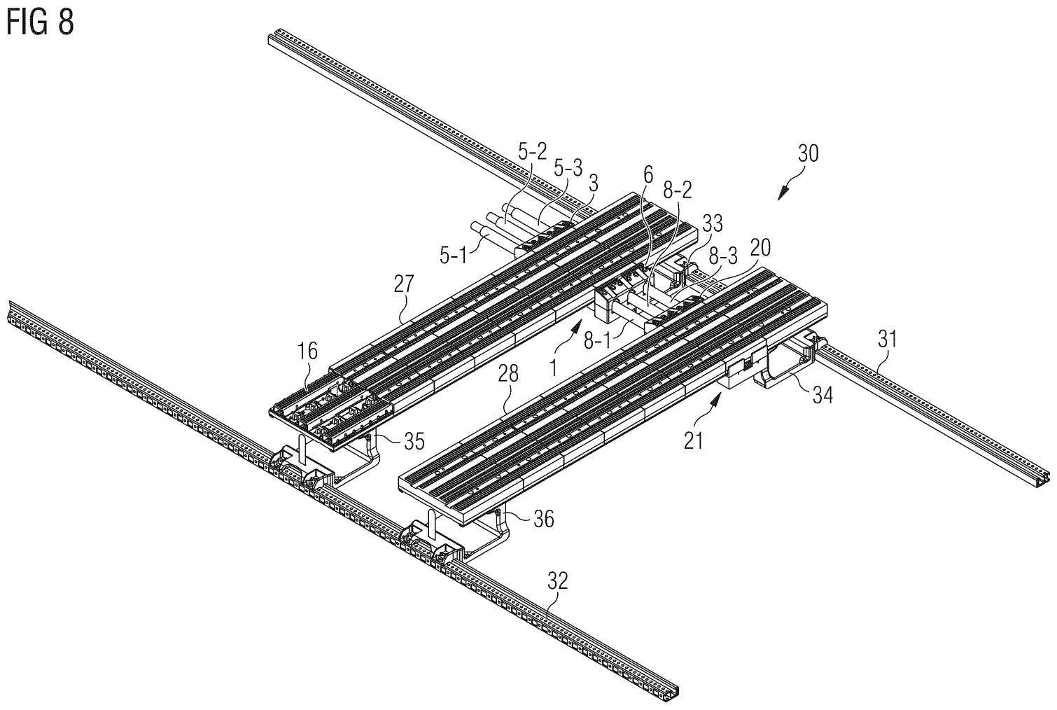

The control cabinet comprises a mounting platform which can be used to mount the main power supply module 1, an associated extension power supply module 21 as well as auxiliary modules 25, 26 as illustrated in FIGS. 6, 7. The auxiliary modules 25, 26 can be mounted on the mounting platform 2 of the control cabinet to provide mechanical support to the busbars 16-i connected to the at least one main power supply module 1 and to the busbars mounted to the extension power supply module 21. In a preferred embodiment, the structure of the auxiliary modules 25, 26 is similar to the structure of the power supply modules, however, without the provision of contact blocks. In a possible embodiment, the busbars 16 of the power distribution busbar system can be integrated in housings of the touch-protected busbar boards 27, 28 as illustrated in FIGS. 6, 8.

As can be seen in FIG. 6, a first touch-protected busbar board 27 is mounted on the main power supply module 1 and its associated auxiliary support module 25. A second touch-protected busbar board 28 is mounted on the extension power supply module 21 and its associated mechanical auxiliary support module 26. Both touch-protected busbar boards 27, 28 can comprise a predetermined number of busbars 16 integrated within the housing of the respective touch-protected busbar board 27, 28. In the illustrated embodiment of FIG. 6, the control cabinet comprises a mounting plate 2 to which the power supply module 1, the associated extension power supply module 21 and the associated auxiliary support modules 25, 26 are fixed, for instance by means of screws. The front side of the touch-protected busbar boards 27, 28 comprises several (e.g. three) rows 50-1, 50-2, 50-3 each comprising a plurality of equidistant contact openings 51 (e.g. slots) corresponding to the slots 16A of the underlying busbars 16-i of the power distribution busbar system. In this way, it is possible to plug protruding electrical contacts 39 of busbar components 40 such as motor starters or switch disconnectors or other kinds of power supply control apparatuses through the contact openings 51 at the front side of the housing of the busbar boards 27, 28 into the corresponding slots 16A of the busbars 16-i encapsulated by the housing of the respective busbar board 27,28 of the power distribution busbar system.

In a possible embodiment of the power supply module 1, the associated extension power supply module 21 as well as the auxiliary support modules 25, 26 comprise assembly elements adapted to receive engaging elements provided on a rear side of a housing of a touch-protected busbar board 27, 28 which can be used for a tool-free assembly of the touch-protected busbar board 27, 28 on the respective modules mounted on the mounting plate 2 of the control cabinet. In this way, a user can clip a busbar board such as the busbar board 27, 28 illustrated in FIG. 6 without using any kind of tool onto the power supply modules 1, 21 and associated mechanical auxiliary support modules 25, 26. In this way, the mounting of the touch-protected busbar boards 27, 28 can be performed easily and in a complete safe manner without requiring the use of a tool.

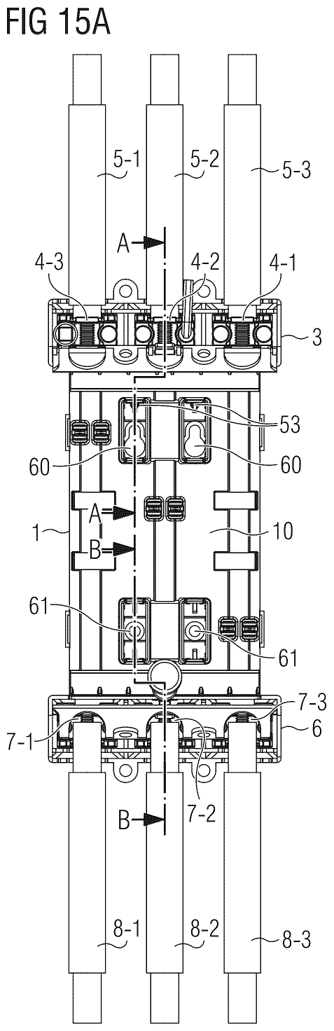

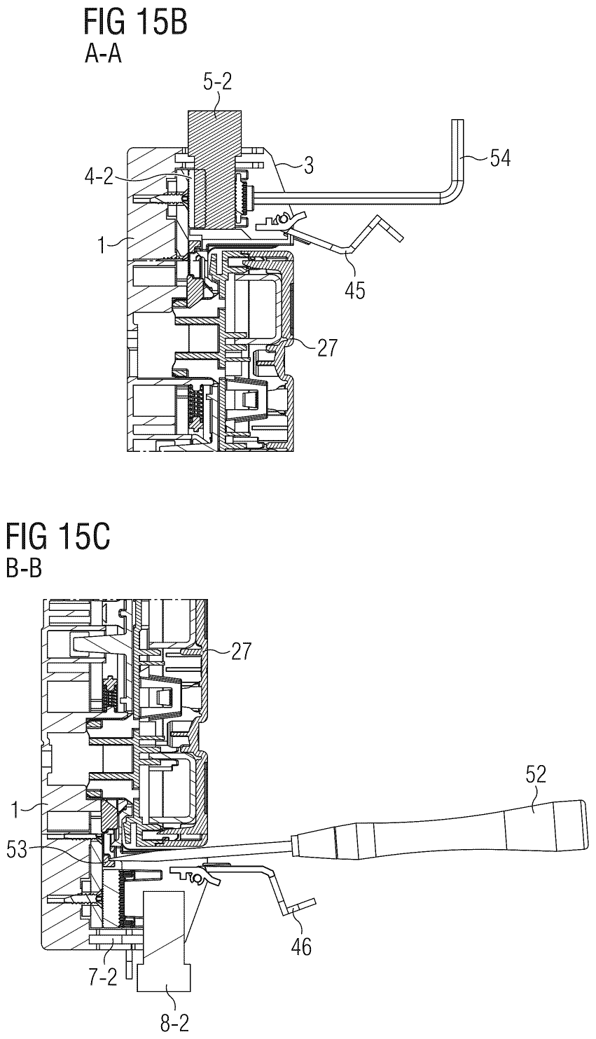

In a further possible embodiment, the assembly element of the power supply module 1, of the associated extension power supply module 21 and of the associated mechanical auxiliary modules 25, 26 used for the tool-free assembly of the touch-protected busbar boards 27, 28 is after removal of a corresponding touch protection cover element 45, 46 accessible by a tool 52 such as a screwdriver. This tool 52 can be used for disengaging the locking part 53 being integrated in the respective modules 1, 21, 25, 26 or being provided on the rear side of the housing of the touch-protected busbar board 27, 28 from the assembly elements for removal of the touch-protected busbar boards 27, 28 from the respective modules fixed to the mounting plate 2 of the control cabinet. For instance, a user can after removal or opening of a touch protection cover element 45, 46, 47 make use of a screwdriver 52 for disassembly of the touch-protected busbar boards 27, 28 from the corresponding modules as also shown in FIGS. 15C, 16, 17B, 17C.

In a possible embodiment each power supply module 1, 21 and each auxiliary support module 25, 26 can comprise two locking parts 53. To remove the busbar boards 27, 28 from the power supply module 1,21 and from the associated auxiliary support module 25,26 the upper engaging element 53 is drawn by the screw driver 52 in a positive Y-direction and the lower engaging element 53 in a negative Y-direction. In the disengaged position the respective locking part 53 then releases the busbar board 27, 28, i.e. moving the busbar board 27, 28 in Z-direction is now possible. To avoid that a user has to handle all four elements simultaneously there is a fixed state in disengaged position (parking position) for each locking part 53. In its engaged locking position the locking part 53 does restrict the degree of moving freedom of the busbar boards in Z-direction.

FIG. 7 shows the mechanical support auxiliary modules 25, 26 used for receiving the busbar boards 27, 28 of the power distribution busbar system in a coordinate system having a X-direction, a Y-direction and a Z-direction. The auxiliary support modules 25, 26 also comprise electrically isolating contact cover portions 62, 63 of for receiving portions of busbars 16, however, these cover portions 62, 63 are only provided for mechanical purposes without transporting an electrical current.

In the embodiments illustrated in FIG. 1 to FIG. 7, the power supply distribution busbar system is mounted on a mounting plate 2.

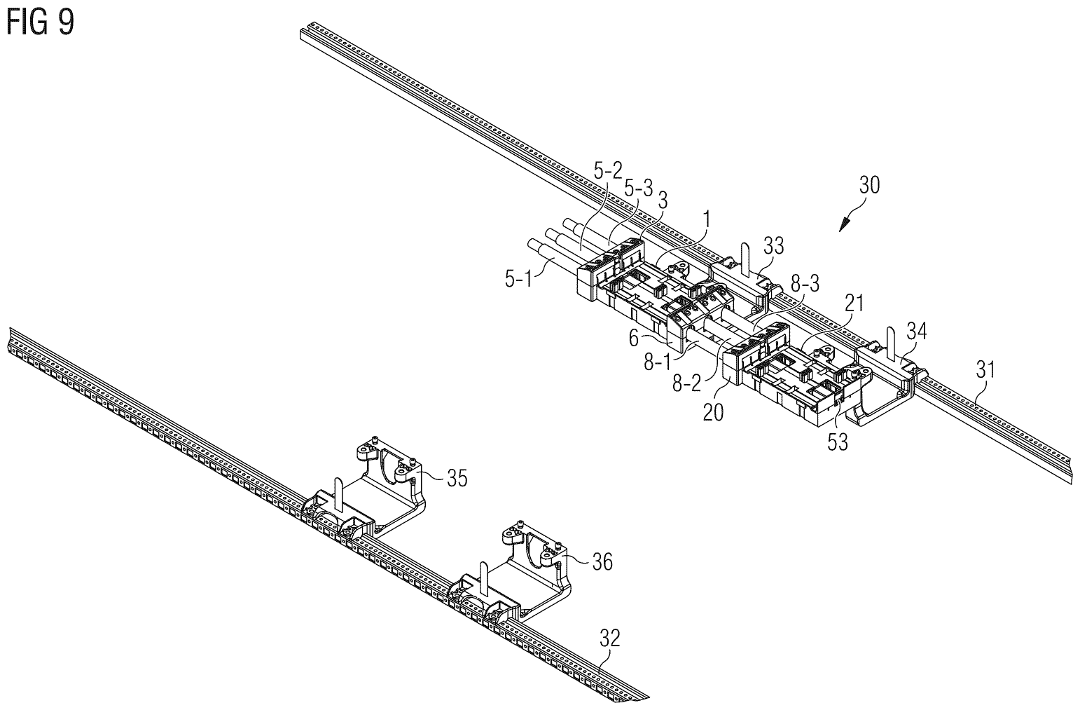

In an alternative embodiment, the busbar boards 27, 28 of the power distribution busbar system can also be mounted on a frame mounted busbar system 30 as illustrated in FIGS. 8, 9 having at least two supporting bars 31, 32. In the illustrated embodiment, brackets 33, 34 are used for fixing busbar boards 27, 28 to a first supporting bar 31 of the frame mounted busbar system 30. Further, brackets 35, 36 can be used to fix the other distal end of the busbar boards 27, 28 with the integrated busbars 16 to the other opposing supporting bar 32 of the frame mounted busbar system 30. Initially the brackets 33 to 36 are fixed to the supporting bars 31, 32. Then the busbar boards 27, 28 are fixed to the brackets 33 to 36. Finally, the power supply module 1 is plugged from behind into the busbar boards 27, 28 and is attached in this way to the busbar boards 27, 28.

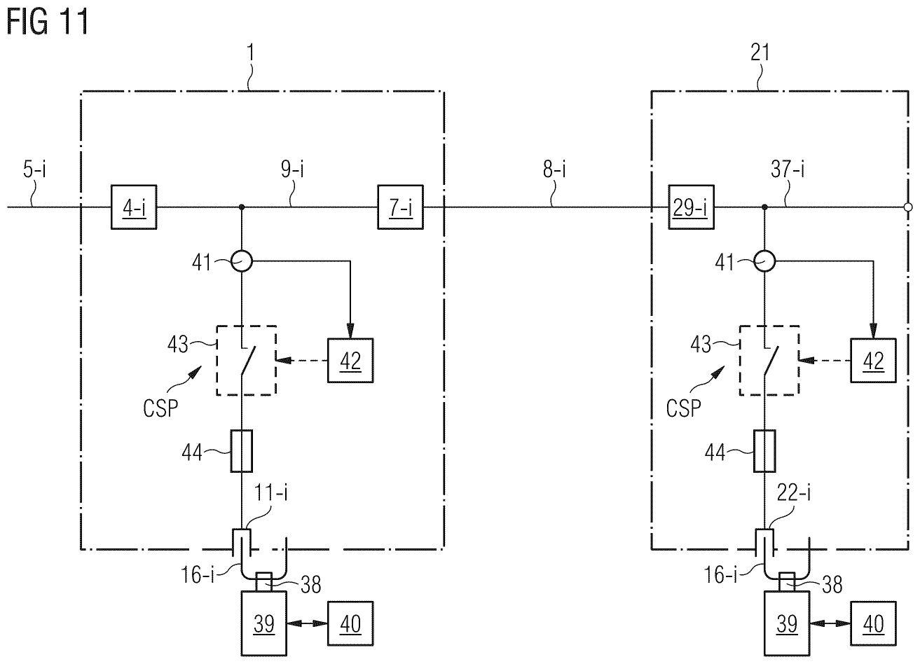

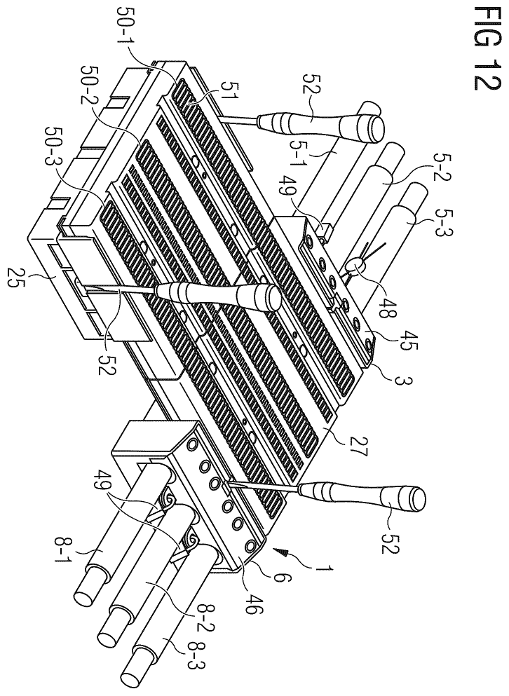

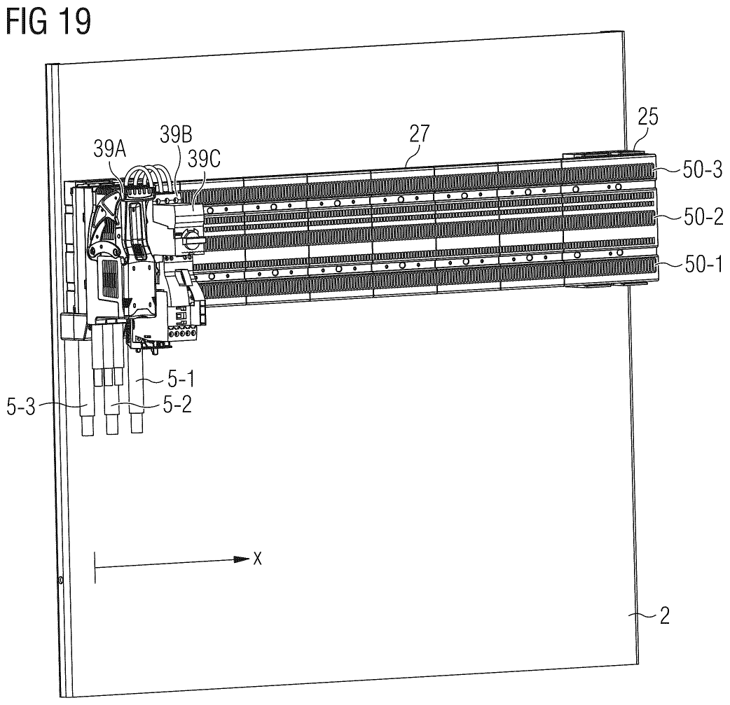

The power supply modules 1, 21, i.e. the main power supply module 1 as well as the extension power supply module 21, can each comprise an internal electrical current supply path CSP provided between a clamping contact 4 of the first clamping block 3, 20 of the respective power supply module 1, 21 and an associated busbar 16 of the power distribution busbar system through an intermediate bar 9 of the respective power supply module 1, 21 as also shown in FIG. 10. In a possible implementation, the power supply module 1 can comprise for each internal current supply path CSP a current sensor element 41 adapted to measure an electrical current I flowing through the respective current supply path CSP and/or comprise a voltage sensor element adapted to measure a voltage V applied to the respective current supply path CSP. The internal current supply path CSP can comprise further elements such as a switch 43 or a fuse element 44 as shown in FIG. 11. The internal current supply paths CSPs of the power supply module 1 can comprise in a possible embodiment each a manually operated or controllable switching element 43 for interruption of the respective internal current supply path CSP of the power supply module 1 as illustrated schematically in FIG. 11 to provide protection, in particular overcurrent protection and/or overload protection, to electrical load devices 40 receiving their power supply through busbar components 39 connected to busbars 16 of the power distribution busbar system. The controllable switching element 43 can comprise in a possible implementation a semiconductor power switch controlled by an integrated control unit 42 of the power supply module 1 in response to sensor signals generated by sensor elements 41 of the respective power supply module 1. Further, the power supply module 1 can comprise in a possible implementation a display unit adapted to display a momentary switching state of integrated switching elements 43 or to display measurement information provided by integrated sensor elements 41 and/or adapted to display states of integrated fuse elements 44 of the respective power supply module 1. Further the display unit of the power supply module 1 can display momentary operation states of the busbar components 39 and/or of their load devices 40. The busbar components 39 are accessible to a user from a front side of the control cabinet as also shown in FIG. 19. Some of the busbar components 39 can comprise a user interface at a front side of a housing of the busbar component.

The internal current supply path CSP can be a bidirectional current supply path, i.e. the device 40 connected to the busbar component 39 can be a power consuming load device but also a power generating device providing electrical power fed back in a reverse power supply direction from the power generating device through the busbar component 39 and through the power supply module 1 into the power distribution system of the control cabinet where the electrical power is distributed to load devices of the control cabinet.

FIGS. 10, 11 illustrate schematically a power supply module 1 according to the first aspect of the present invention. As can be seen in the diagram of FIG. 10, the clamping contact 4-i provided at the first clamping block 3 of the main power supply module 1 is internally electrically connected through an intermediate bar 9-i to an associated clamping contact 7-i provided at the opposing contact block 6 of the main power supply module 1. The outgoing clamping contact 7-i of the main power supply module 1 is connected via an extension conductor 8-i to a corresponding input clamping contact 29-i of the contact block 20 of the extension power supply module 21. The extension power supply module 21 comprises internal intermediate bars 37-i as shown in FIG. 10. The main power supply module 1 comprises front side touch protected electrical contacts 11-i connected internally to the intermediate bars 9-i of the main power supply module 1. In the same way, the extension power supply module 21 comprises front side touch protected electrical contacts 22-i connected to the internal intermediate busbars 37-i of the extension power supply module 21. A portion of each busbar 16 is plugged between the surfaces of the electrical contacts such as electrical lyre or U-shaped contacts 11-i, 22-i of the power supply modules 1, 21 as shown in FIG. 10. The busbars 16 can in turn comprise contact slots 16A or other contact means to receive electrical contacts 38 of busbar components 39 connectable to the busbars 16 of the power distribution busbar system of the control cabinet as illustrated schematically in FIG. 10. The busbars 16 are integrated in a preferred embodiment in a touch protected busbar board 27, 28.

The busbar components 39 are accessible by a used and provided at the front side of the control cabinet. Busbar components 39 can comprise for instance motor starters, switch disconnectors, circuit breakers or other kinds of power supply control apparatuses. Further, the busbar components 39 can also comprise adapter devices such as the adapter device 39B shown in FIG. 19. In a possible embodiment, to each busbar component 39, at least one electrical load device 40 or electrical power generation or power storage device can be connected through an interface at a front side of the busbar component 39.

The electrical load device 40 can comprise a resistive load, a capacitive load or an inductive load such as a motor connectable to a corresponding busbar component 39 such as a motor starter being connected to busbars 16 of the power distribution busbar system of the control cabinet to receive a power supply via the busbar component 39. In the illustrated embodiments of FIG. 10, the different busbar components 39 can be plugged into slots 16A of the U-shaped busbars 16-i which can be integrated in a housing of a touch-protected busbar board such as the busbar boards 27, 28.

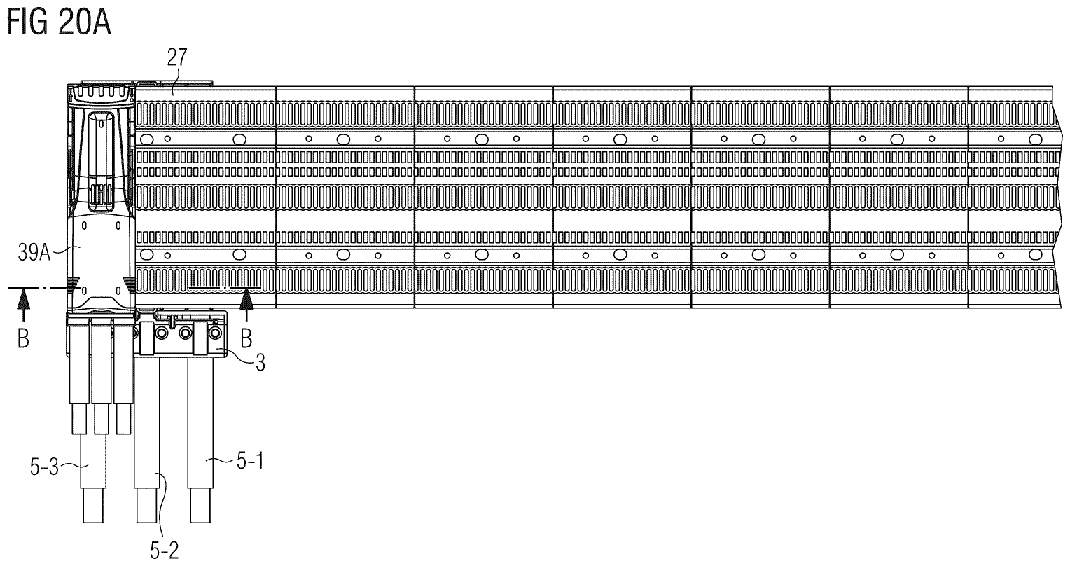

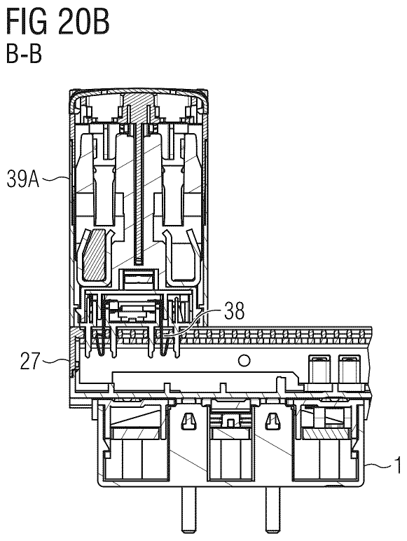

Further a load device 40 or a power generation device 40 can be connected to an interface at the front side of the housing of the busbar component 39 which is connected by its contacts 38 to busbars 16 integrated in a busbar board 27 of the power distribution system of said control cabinet as also shown in FIG. 20B forming a cross section view of FIG. 20A along line B-B.

In this way it is also possible to feed electrical power into the power distribution busbar system of the control cabinet from local power generation devices. The power generation or storage device can be for instance comprise a battery providing DC power or comprise a generator providing AC power.

Accordingly, an electrical current can flow in two directions, i.e. in a forward supply direction from the power distribution system to a load device 40 or in a reverse supply direction from a power generation device 40 back into local the power distribution system of the control cabinet. In a possible implementation the power supply direction, i.e. the direction of the flow of electrical current I flowing along the current supply path CSP is detected by sensor elements provided at the current supply path CSP and notified to the controller 42 shown in FIG. 11. This information can used for performing a local power balancing and/or for protection of connected entities 40 by controllers 42 communicating with each other through a wireless or wired communication interface.

FIG. 19 illustrates the mounting of exemplary busbar components 39A, 39B, 39C on the front side of the busbar board 27 mounted in X-direction on a mounting plate 2 of the control cabinet. The busbar board 27 with its integrated busbars 16 is mounted in a preferred embodiment in a horizontal direction onto the mounting platform, i.e. in this embodiment the X-direction is horizontal. The busbar component 39A comprises a fuse switch disconnector. The busbar component 39B is an adapter onto which a motor starter 39 is assembled.

FIG. 11 shows a further exemplary embodiment of power supply modules 1, 21 with additional protection circuitry for protection of electrical loads 40 connected to the busbar components 39 of the system. In the illustrated embodiment of FIG. 11, the main power supply module 1 and the extension power supply module 21 both comprise a sensor element 41 provided in the internal current supply path CSP of the respective power supply module 1, 21. The sensor element 41 can comprise for instance a current sensor element adapted to measure an electrical current I flowing through the respective current supply path CSP via the busbar component 39 to an electrical load 40 mounted in the control cabinet. The sensor signal of the current sensor element 41 can be supplied to an integrated controller 42 provided within the main power supply module 1 and/or within the extension power supply module 21 as illustrated in FIG. 11. In a further possible embodiment, the power supply modules 1, 21 can also comprise a voltage sensor element adapted to measure a voltage applied to the respective current supply path. The sensor elements can provide sensor signals sampled by ADCs of the power supply module and stored as sensor data in a memory of the controller 42. The sensor data comprises a current profile and/or a voltage profile which can be processed by a processor of the controller 42 for overcurrent and/or overvoltage and/or overload detection or other fault events. In case of a detected fault event the controller 42 triggers the interruption of the affected current supply path CSP. The controller 42 can communicate in a possible embodiment with a control cabinet controller of the control cabinet via a wired or wireless communication link. In this way the control cabinet controller can be notified about a momentary operation state of the respective power supply module 1. The control cabinet controller can control the electrical connection of the local power distribution system integrated in the control cabinet to an external power supply system such as a power supply grid and/or can control the electrical connection of the local power distribution system to the power supply modules 1 of the control cabinet depending on the notified operation states of the power supply modules 1 of the control cabinet. For instance, if an auxiliary light sensitive sensor indicates that a protection cover 45, 46 of a contact clamping block 3,6 has been opened by a user the affected power supply module 1 can be separated automatically by a switch controlled by the control cabinet controller from the local power distribution system of the control cabinet to protect the user.

The current supply path CSP of the power supply modules 1, 21 can comprise in a possible implementation a manually operated and/or a controllable switching element 43 used for interruption of the respective internal current supply path CSP of the power supply module 1 to provide protection to electrical loads 40 receiving the power supply through the busbar components 39 connected to the busbars 16 of the power distribution busbar system. In a possible embodiment, the switching element 43 can comprise a controllable semiconductor power switch (e.g. MOSFET) controlled by the integrated control unit 42 of the respective power supply module 1, 21 in response to sensor signals generated by sensor elements such as the current sensor element 41 of the power supply modules 1, 21. Each power supply module 1, 21 can comprise in a further implementation a display unit with a graphical user interface GUI adapted to display a momentary switching state of the integrated switching elements 43 and/or to display measurement information measured by integrated sensor elements 41 and/or to display states of integrated fuse elements 44 as illustrated in FIG. 11. Auxiliary sensor elements, in particular light sensitive sensor elements, may be used to detect whether cover elements 45, 46 have been opened by a user or not.

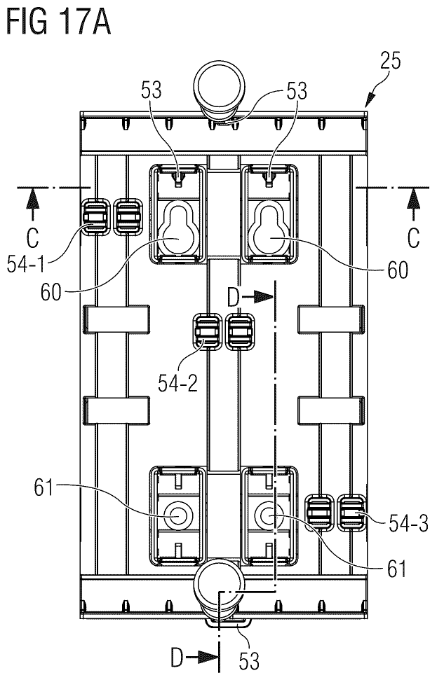

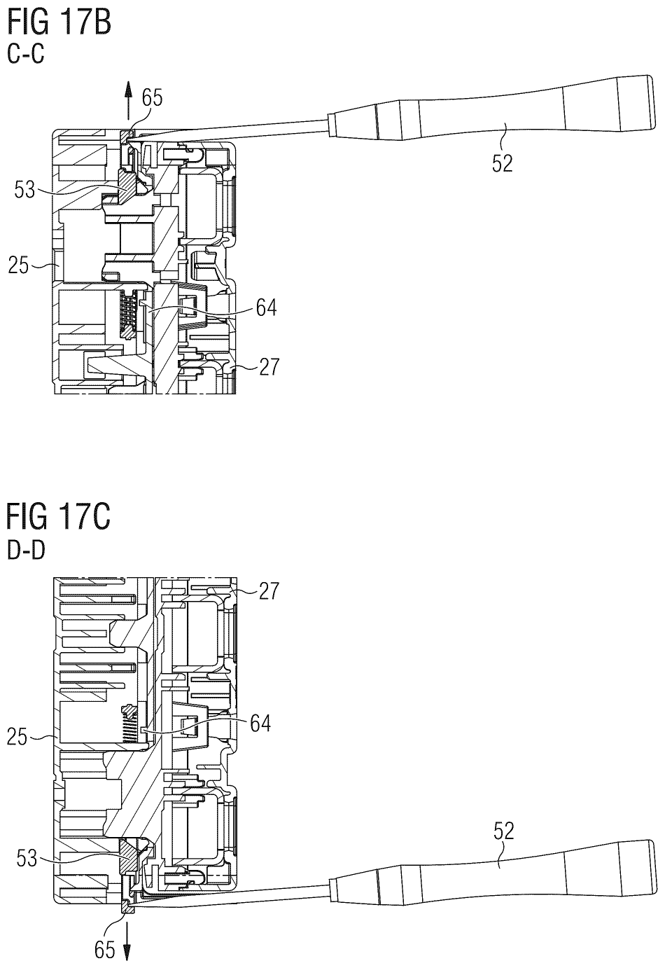

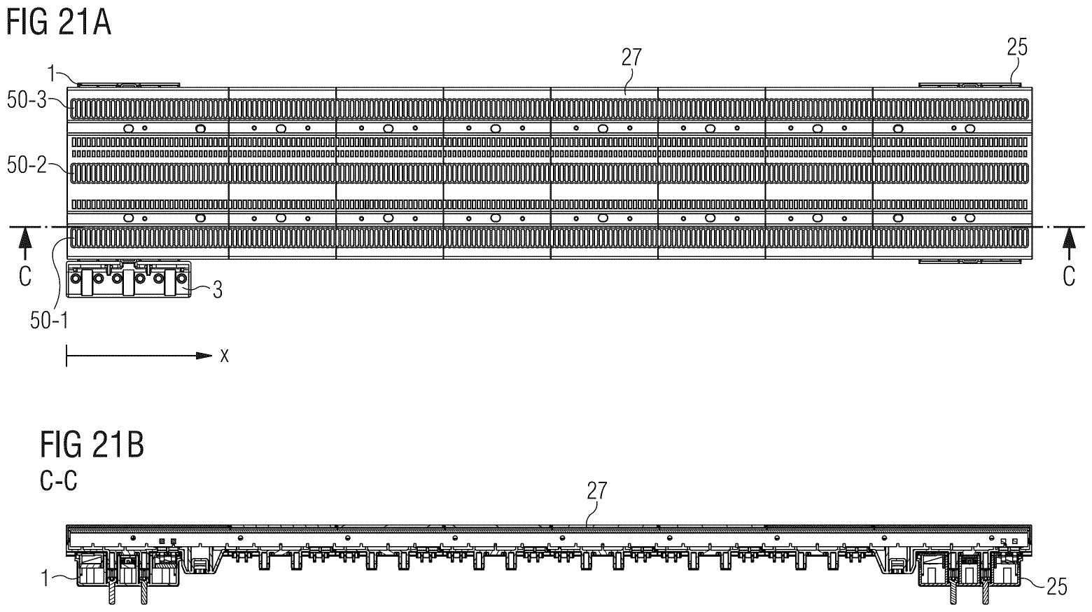

The power supply module 1 and the associated extension power supply module 21 provide in a preferred embodiment IP20 touch protection for a user. In a possible embodiment, the busbars 16-i integrated in the busbar boards 27, 28 can be mounted on a mechanical platform of the control cabinet in horizontal direction. In a possible embodiment, the associated auxiliary modules 25, 26 as illustrated in FIG. 7 comprise recesses adapted to receive engaging elements. The auxiliary support modules 25, 26 can be provided for tolerance compensation of manufactured assembly holes of the power supply module and of the auxiliary support module. For instance, the recesses of the mechanical support modules 25, 26 comprise a wiggle room of three millimeters to provide tolerance compensation to provide mechanical tolerance compensation in X-direction for manufactured screw holes of the power supply module 1 and of its associated auxiliary support module 25 as also visible in FIG. 17A and in FIGS. 21A, 21B.

The power supply module 1 and the auxiliary support module 25 are both formed such that they can mechanically compensate manufacturing tolerances of their assembly holes in X-direction as shown in FIG. 7 and in FIGS. 21A, 21B. The power supply module 1 forms a fixed bearing for the busbar board 27 and the auxiliary support module 25 forms a loose bearing for the busbar board 27. This can be achieved in that a width A of receiving pockets of the auxiliary support module 25 is larger than a width B of the receiving pockets of the power supply module 1 as illustrated in FIG. 7.

The number N of busbars 16-i of the power distribution busbar system can vary depending on the use case. In the illustrated embodiment, the power distribution busbar system comprises N=3 busbars 16-1, 16-2, 16-3 for three different current phases L1, L2, L3 of an AC power supply system. In other use cases, the power supply modules 1, 21 can comprise N=4 busbars or N=5 busbars to a power distribution system with an N busbar and/or a PE busbar. The power distribution system can also be used for DC power supply of electrical loads 40 though busbar components 39 plugged into contact slots 16A of busbars 16 of the power distribution system.

The main power supply module 1 may or may not comprise a connected extension power supply module 21. Accordingly, the provision of the extension power supply module 21 is optional. The main power supply module 1 without the extension power supply module 21 can be turned around along its longitudinal axis by 180° to provide either power supply through the electrical conductors 5-i from above or from the bottom of the control cabinet. For insulation of components of the busbar system, all parts are electrically isolated to provide safety for a user performing maintenance or repair services. The busbar components 39 can be plugged in a possible embodiment without use of any mechanical tools into the busbars 16 of the touch-protected busbar board 26, 28. The busbars 16 are adapted to collect electrical power from the power supply modules 1, 21. The power supply modules 1, 21 of the power distribution busbar system can also be used as outgoing feeders receiving electrical power from busbars 16-i and to supply the electrical power to external components.

The busbars 16-i of the electrical power supply system can comprise different shapes. In the illustrated embodiment, the busbars 16-i are formed by U-shaped busbars. The electrical busbars 16-i can also comprise other cross sections or shapes, for instance, they can comprise conventional electrical busbars having rectangular cross-sections. Other shapes are possible as well. For instance, the electrical busbars 16 may also comprise a round cross section.

The power distribution busbar system can comprise a couple of busbar holders for assembly. The electrical busbar system can be differentiated by the distance between the center of each busbar 16-i and may vary according to a maximum current carrying capacity of the power distribution busbar system. In a possible embodiment, the power distribution busbar system may comprise a 40 mm busbar system having a current carrying capacity of up to 300 to 400 Amps, a 60 mm busbar system having a current carrying capacity of up to 800 to 2500 Amps, a 100 mm busbar system having a current carrying capacity of up to 1250 Amps and/or a 185 mm busbar system comprising a current carrying capacity of up to 2500 Amps.

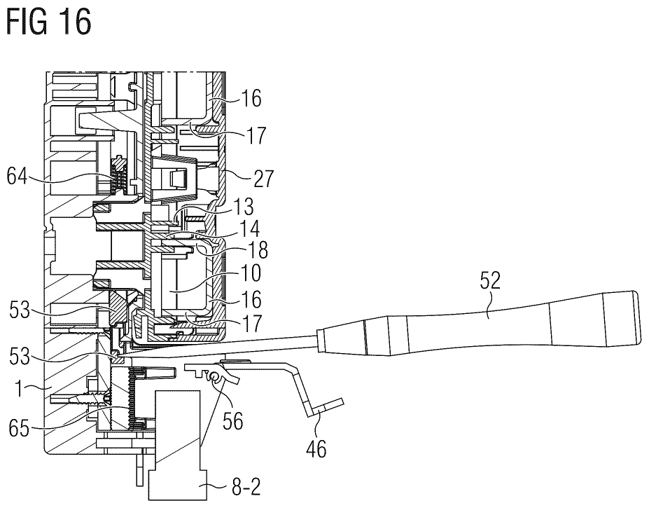

FIG. 12 shows a perspective view on a power supply module 1 and its associated auxiliary support module 25 to illustrate disassembly of a busbar board 27 by means of a tool 52. In the illustrated exemplary embodiment, the tool 52 used for disengaging the busbar board 27 from the rear side power supply module 1 and its associated auxiliary support module 25 comprises a screwdriver. As can be seen in FIG. 12, the main power supply module 1 comprises two contacting blocks 3, 6 each having a touch protection cover element 45, 46. After moving or opening the touch protection cover element 45, 46, the screwdriver 52 gets access to a locking part 53 as illustrated in the cross-section view of FIG. 16. Similarly, the screwdriver 52 can be used for disengaging the busbar board 27 from the auxiliary support module 25 as also illustrated in FIGS. 17A, 17B, 17C. Accordingly, whereas the mounting of the busbar board 27 onto the power supply module 1 and its associated auxiliary support module 25 can be performed without use of a tool 52, the disassembling of the busbar board 27 can only be performed by a user using a tool such as the screwdriver 52 as shown in FIG. 12. As also illustrated in FIG. 12, the touch protection cover elements 45, 46 can further be secured by using a seal 48 or locking elements 49. After removing the seal 48 and/or the locking elements 49, a user can open the corresponding touch protection element 45, 46 to get access to the underlying conductor contacts and to the locking part 53 as can be seen in FIG. 16. The seal 48 and the lock 49 as well as the touch protection cover element 45, 46 secured by the seal 48 and lock 49 guarantee that a user cannot unintentionally come into physical contact with a current carrying contacts 4,7 of the contact clamping blocks 3, 6.

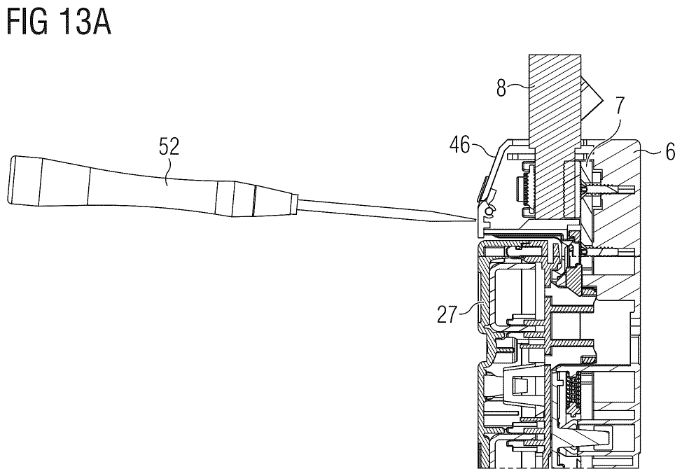

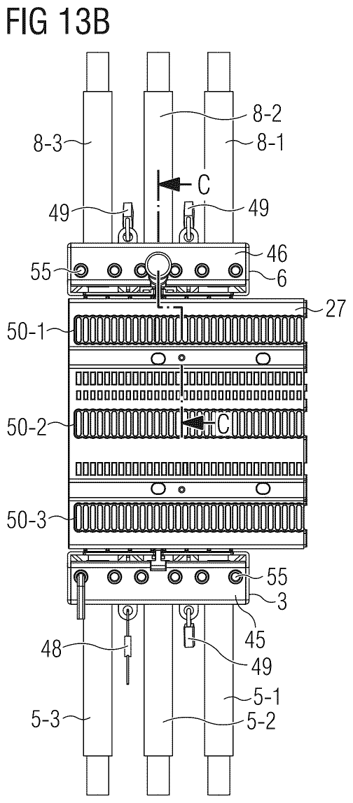

FIGS. 13A, 13B show a cross section view and a front view on the main power supply module 1 as shown in FIG. 12. As can be seen in FIG. 13B, both touch protection elements 45, 46 are closed. Further, both touch protection elements 45, 46 are secured by means of a seal 48 and by locking elements 49. FIG. 13A shows a cross section view along the second contact block 6 with the closed touch protection element 46. As can be seen in FIG. 13A, a user cannot unintentionally come into contact with the contact elements 7 of the contact clamping block 6.

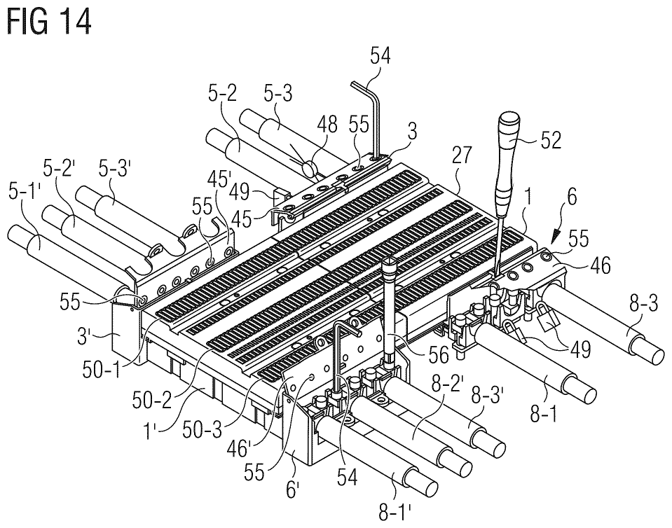

FIG. 14 shows a further exemplary embodiment where two main power supply modules 1, l′ are used to carry a busbar board 27. Accordingly, whereas the busbar board 27 shown in FIG. 6 is supported by a main power supply module 1 and its associated auxiliary support module 25, the busbar board 27 shown in FIG. 14 is mounted on two main rear side power supply modules 1, 1′, having contact clamping blocks 3, 6, 3′, 6′ on both sides. FIG. 14 further illustrates an Allen key 54 which can be used to fix the electrical conductors 5, 8 to the corresponding electrical contacts 4, 7 of the contact clamping blocks 3, 6. In a possible implementation, the touch protection elements 45, 46 comprise corresponding holes or openings 55 through which the Allen key 54 can be passed for fixing the electrical conductors 5, 8 to the corresponding electrical contacts 4, 7. The number of the openings 55 in the housing front side 45, 46 corresponds to the number of conductor contacts 4,7. It is also possible to pivot the touch protection elements 45, 46 to get access to the electrical contacts 4, 7. Also, other kinds of tools such as the tool 56 shown in FIG. 14 can be used for fixing the electrical conductors 5, 8 to the corresponding electrical contacts 4, 7 of the contact clamping blocks 3, 6. As can be seen in FIG. 14, whereas the touch protection elements 45, 46 of the first power supply module 1 are in the illustrated situation closed and sealed or blocked by a seal 48 and/or by locking elements 49, the touch protection elements 45′, 46′ of the second power supply module 1′ have been opened to perform an assembly of the electrical conductors 5, 8 to the corresponding electrical contacts 4, 7′. A user may take a screwdriver 52 to open up the touch protection elements 45, 46 of the other power supply module 1 as well after removal of the seal 48 and locking elements 49 as also shown in FIG. 14. The conductors 5,8 comprise an electrically insulating mantle.

FIGS. 15A, 15B, 15 C illustrate a power supply module 1 with opened-up touch protection elements 45, 46. FIG. 15B shows a cross section view along the line A-A and FIG. 15C shows a cross section view along the line B-B. After having opened up the touch protection cover element 46, a screwdriver 52 can be used for disengaging the busbar board 27 from the main power supply module 1 as illustrated in FIG. 15C and illustrated in more detail in FIG. 16.

At the contact clamping block 3, the Allen key 54 can be used to mount the electrical conductor 5 to the corresponding electrical contact 4-2 of the contact block 3 after having opened the touch protection cover element 45 as shown in FIG. 15B.

FIG. 16 illustrates the separation of the locking part 53 by the tip of a screwdriver 52. As can be seen in FIG. 16, the touch protection cover element 46 can be swiveled or pivoted around an element 56 to open up a passage for entering a tip portion of the screwdriver 52 along the sidewall of the housing of the busbar board 27 wherein the inserted tip portion of the screwdriver 52 is used to move a hook-shaped portion of the locking part 53. In this way, the housing of the busbar board 27 becomes disengaged and can be removed from the underlying power supply module 1. In contrast to the disassembly, the mounting of the busbar board 27 onto the power supply module 1 can be performed without requiring a tool. For mounting the busbar board 27, the housing of the busbar board 27 can simply be clipped onto the locking part 53. The locking part 53 can comprise a spring to move the locking part 53 into a parking position.

For each module there are two locking parts 53 which may be operated independently. Each of the two locking parts 53 is pressed by two associated mechanical springs 64 in a locking position of the respective locking part 53. These (four) mechanical springs 64 can be seen in FIG. 5D and in FIGS. 17B, 17C.

When handling by a screw driver 52 an engaging element of the locking part 53 which can be formed by an engaging hook 65 the locking part 53 is moved against the direction of the mechanical force F exerted by the mechanical spring 64 on the locking part 53 until the engaging hook 65 provided at the locking part 53 does fixate the locking part 53 in the parking position. In the parking position the locking part 53 does release the busbar board 27 so that it can be lifted from the power supply module 1 and from the associated auxiliary support module 25.

For performing a new mechanical engagement, the engaging hook 65 of the locking part 53 is pressed back by the screw driver 52 and the associated mechanical springs 64 do press the locking part 53 back into its locking position.

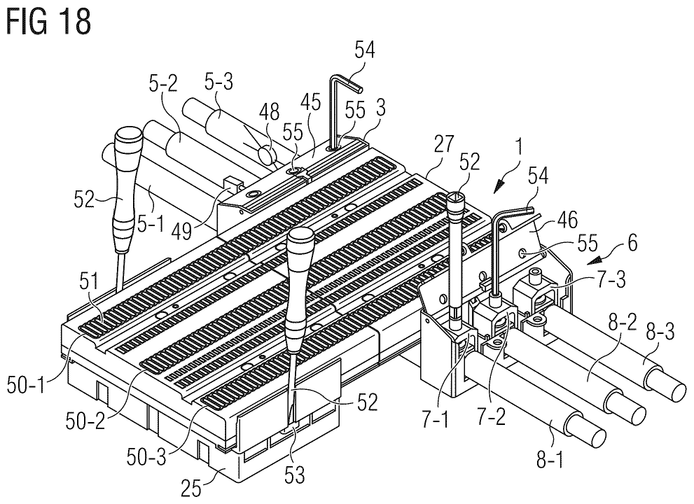

FIGS. 17A, 17B, 17C illustrate the disassembly of the busbar board 27 from an auxiliary support module 25 by means of a screwdriver 52. The screwdriver 52 can be placed on a hook-shaped tip portion of the locking part 53 forming an engaging hook 65 to receive the tip of the screwdriver 52. The housing of the busbar board 27 can be used in this way as a lever for pushing the hook shaped tip portion of the locking part 53 in lateral direction as illustrated schematically in FIGS. 17B, 17C thus disengaging the housing of the busbar board 27 from the underlying auxiliary support module 25. This is also illustrated in the perspective view of FIG. 18.

As can be seen in FIG. 17A the modules comprise two key shaped holes 60 and two round holes 61. In a preferred orientation, i.e. when the conductors 5 are coming from below within the control cabinet, two screws are pre-screwed into the mounting plate 2 and subsequently the respective module is suspended by means of the two key shaped holes 60 onto these screws. Then the module is fixed with two additional screws through the round holes 61 illustrated in FIG. 17A.

There are further different variants of the power supply module 1 according to the present invention that are not illustrated in FIGS. 1 to 18. For instance, the number of busbars integrated in a busbar board 27 may vary. Accordingly, also the number of front facing electrical contacts 4, 7 of the power supply module 1 can vary depending on the use case. For instance, each power supply module 1 can be used for connection of, for instance, five electrical busbars carrying AC power supply phases L1, L2, L3 as well as N or P conductor busbars. In a possible embodiment, the power supply module 1 further comprises a control interface which is adapted to establish a communication between the controller 42 illustrated in FIG. 11 and an external controller of the control cabinet. In a further implementation, optical sensor elements can also be used to detect whether touch protection elements 45, 46 have been opened to increase security of the user.

### Further Embodiments

A power supply module 1 for rear-side power supply of a power distribution busbar system comprising a number, N, of busbars 16 for distribution of electrical power for busbar components 39 connectable to said busbars 16,
said rear side power supply module 1 comprising:
   at least one clamping block 3; 6 having a number, N, of clamping contacts 4; 7 adapted to clamp electrical conductors 5; 8 to said clamping block 3; 6;
   a number, N, of electrically conductive and touch protected intermediate bars 9 provided between the at least one clamping block 3;6 and a number, N, of touch-protected electrical contacts 11 provided at a front side of said power supply module 1 and adapted to establish an electrical connection between the busbars 16 of said power distribution busbar system and the intermediate bars 9 of said power supply module 1.

The power supply module according to embodiment 1 wherein the power supply module 1 comprises:
a first clamping block 3 having a number, N, of clamping contacts 4 adapted to clamp electrical conductors 5 to said first clamping block 3; and
a second clamping block 6 having a number, N, of clamping contacts 7 adapted to clamp electrical conductors 8 to said second clamping block 6,
wherein the intermediate bars 9 are provided between said first clamping block 3 and said second clamping block 6 to provide electrical connection between the electrical conductors 5 clamped to clamping contacts 4 of the first clamping block 3 and the electrical conductors 8 clamped to the clamping contacts 7 of the second clamping block 6 of said power supply module 1.

The power supply module according to embodiment 1 or 2 wherein the touch-protected front side electrical contact 11 comprises an electrical lyre or U-shaped contact having a base contact portion 12 connecting two opposing leg contact portions 13, 14 of said electrical lyre or U-shaped contact 11.

The power supply module according to embodiment 3 wherein the base contact portion 12 of the electrical lyre or U-shaped contact 11 is electrically connected to an associated intermediate bar 9 of said power supply module 1.

The power supply module according to embodiment 3 or 4 wherein the two leg contact portions 13, 14 of the electrical lyre or U-shaped contact 11 are touch protected by electrically isolating contact cover portions 57,58 of an electrically isolating housing front side 10 adapted to cover the associated intermediate bars 9 lying beneath the housing front side 10.

The power supply module according to embodiment 5 wherein a portion of a busbar 16 of the power distribution busbar system is pluggable between the electrical contact surfaces of the two leg contact portions 13, 14 of the electrical lyre or U-shaped contact 11 to establish an electrical connection between the busbar 16 of the power distribution busbar system and an intermediate bar 9 of said power supply module 1 through said electrical lyre or U-shaped contact 11.

The power supply module according to embodiment 6 wherein the two leg contact portions 13, 14 of the electrical lyre or U-shaped contact 11 facing each other and encompassing a portion of a busbar 16 of said power distribution busbar system are attracted to each other in response to an electrical overcurrent flowing through the electrical lyre or U-shaped contact 11 and are pressed against the encompassed portion of the busbar 16 to prevent a separation of the busbar 16 from the electrical lyre or U-shaped contact 11 of the power supply module 1 and to prevent the generation of an electrical arc.

The power supply module according to the preceding embodiments wherein the busbar 16 of the power distribution system has a U-shaped profile with two opposing busbar sidewalls 17, 18 connected by a busbar base portion 19 of the busbar 16,
wherein a sidewall of said U-shaped busbar 16 is pluggable between the electrical contact surfaces of the two leg contact portions 13, 14 of the respective electrical lyre or U-shaped contact 11 to establish an electrical connection between the U-shaped busbar 16 and the intermediate bar 9 through the electrical lyre or U-shaped contact 11.

The power supply module according to embodiment 8 wherein the busbar base portion 19 of the U-shaped busbar 16 of said power distribution busbar system comprises contact slots 16A adapted to receive protruding electrical contacts 38 of busbar components 39 pluggable into the contact slots 20 of the busbar base portion 19 of said U-shaped busbar 16.

The power supply module according to any of the preceding embodiments 1 to 9 wherein the at least one clamping block 3; 6 of the power supply module 1 is touch-protected by associated removable or movable touch protection cover elements 45; 46, wherein the removable or moveable touch protection cover element 45,46 of the at least one clamping block 3; 6 is secured by a sealing element 48 or by a lock element 49 against unintentional removal of the touch protection cover element 45; 46 by a user.

The power supply module according to any of the preceding embodiments 1 to 10 wherein the clamping contacts 4, 7 of the at least one clamping block 3, 6 comprise prism clamp contacts or box terminal contacts or comprise a screw system for cable lugs.

The power supply module according to any of the preceding embodiments 2 to 11 wherein the clamping contacts 7 of the second clamping block 6 of said power supply module 1 provide a loop-through functionality to loop the electrical conductors 5 clamped to the clamping contacts 4 of the first clamping block 3 of said power supply module 1 via intermediate conductors 8 to clamping contacts of a clamping block 20 of an extension power supply module 21 provided for rear-side power supply of further busbars 16 of said power distribution system.

The power supply module according to any of the preceding embodiments 1 to 12 wherein a busbar board 27 with integrated busbars 16 of the power distribution system is mounted on the power supply module 1 and on an associated auxiliary support module 25 and wherein the power supply module 1 and its associated auxiliary module 25 are used to provide mechanical support to the mounted busbar board 27 and are adapted to provide a mechanical tolerance compensation for manufactured screw holes on the mounting plate 2 of the power supply module 1 and the associated auxiliary support module 25.

The power supply module according to any of the preceding embodiments 1 to 13 wherein the power supply module 1, an associated extension power supply module 21 and associated auxiliary modules 25, 26 are mounted on a mounting platform 2; 30 of a control cabinet,
wherein the mounting platform of the control cabinet comprises a mounting plate 2 to which the power supply module 1, the associated extension power supply module 21 and the auxiliary modules 25, 26 are fixed by means of fixing screws 59 or wherein the mounting platform comprises a frame mounted busbar system 30 having supporting bars 31, 32 to which busbar boards 27, 28 are fixed by means of brackets 33-36 and wherein the power supply module 1 and the extension power supply module 21 are plugged into the rear side of the busbar boards 27, 28.

The power supply module according to any of the preceding embodiments 1 to 14 wherein the busbars 16 of the power distribution busbar system are integrated in a housing of a touch-protected busbar board 27, 28.

The power supply module according to any of the preceding embodiments wherein the power supply module 1, the associated extension power supply module 21 and the associated auxiliary modules 25, 26 comprise integrated assembly elements of a locking part 53 used for a tool-free assembly of the touch-protected busbar board (27, 28 on the respective modules 1, 21, 25, 26.

The power supply module according to embodiment 16 wherein the locking part 53 of the power supply module 1, of the associated extension power supply module 21 and of the associated auxiliary modules 25, 26 used for a tool-free assembly of the touch-protected busbar board 27, 28 on the respective module is after removal of a touch protection cover element 45,46,47 accessible by a tool 52 used for disengaging the engaged locking part 53 integrated at the front side within the respective modules 1, 21, 25, 26 or provided on the rear side of the housing of the touch-protected busbar board 27, 28 from the assembly element for removal of the touch-protected busbar board 27, 28 from the respective modules 1, 21, 25, 26.

The power supply module according to the preceding embodiments 1 to 17 wherein an internal electrical current supply path is provided between a clamping contact 4 of the first clamping block 3 of the power supply module 1 and an associated busbar 16 of the power distribution busbar system through an intermediate bar 9 of said power supply module 1, wherein the power supply module 1 comprises for each internal current supply path a current sensor element 41 adapted to measure an electrical current flowing through the respective current supply path and/or comprises a voltage sensor element adapted to measure a voltage applied to the respective current supply path and/or comprises a fuse element 44.

The power supply module according to embodiment 18 wherein the internal current supply path of the power supply module 1 comprises a manually operated or controllable switching element 43 for interruption of the respective internal current supply path CSP of the power supply module 1 to provide protection, in particular overcurrent protection or overload protection, to loads 40 receiving their power supply through busbar components 39 connected to busbars 16 of the power distribution busbar system, wherein the controllable switching element 43 comprises a semiconductor power switch controlled by an integrated control unit 42 of said power supply module 1 in response to sensor signals generated by sensor elements 41 of the power supply module 1 and/or comprises an electromechanical switching element.

The power supply module according to any of the preceding embodiments 1 to 19 wherein a busbar board 27; 28 is mountable to the power supply module 1 manually without using a tool and is removable from the power supply module 1 by means of a manually operated tool 52 adapted to disengage mechanically sprung assembly elements of a locking part 53 integrated and accessible at the front side of the housing of the respective module.

The power supply module according to any of the preceding embodiments 1 to 20 wherein the power supply module 1 is turnable along the z axis by 180 degrees on the mounting platform such that its clamping block is facing an external power supply.

A control cabinet comprising a mounting platform for mounting at least one power supply module 1 according to any of the preceding embodiments 1 to 21 used for a rear-side power supply of power consuming load devices 40 through busbar components 39 provided at a front side of the control cabinet by a power distribution busbar system of said control cabinet.

23. The control cabinet according to embodiment 22 wherein the power distribution system comprises a number, N, of busbars 16 used for distribution of AC power or for distribution of DC power among busbar components 39 connected through electrical contacts 38 to the busbars 16 of the power distribution system and/or used for powerline communication between busbar components 39 connected to the busbars 16 of the power distribution system,
wherein a resistive, a capacitive or an inductive power consuming load device 40 is connectable to a busbar component 39 being connected through the electrical contacts 38, busbars 16 and a current supply path CSP of the power supply module 1 to the power distribution system of said control cabinet to receive an electrical power supply via said busbar component 39 and/or
wherein a power generation device 40 is connectable to a busbar component 39 being connected through the electrical contacts 38, busbars 16 and a current supply path CSP of the power supply module 1 to the power distribution system of said control cabinet to provide electrical power for the power distribution system of said control cabinet.

### REFERENCE NUMBERS

1 main rear side power supply module
2 mounting plate
3 first clamping block
4 clamping contacts
5 conductors
6 second clamping block
7 clamping contacts
8 conductors
9 intermediate bars
10 housing front side
11 touch protected front side contacts
12 contact base portion
13 contact leg portion
14 contact leg portion
15 housing back side
16 busbar
17 busbar sidewalls
18 busbar sidewalls
19 busbar base portion
20 clamping block
21 extension supply module
22 touch protected front side contact
23 housing front side
24 housing back side
25 auxiliary support module
26 auxiliary support module
27 busbar board
28 busbar board
29 clamping contact
30 frame mounted busbar system
31 supporting bar
32 supporting bar
33 bracket
34 bracket
35 bracket
36 bracket
37 intermediate bars
38 electrical contact
39 busbar component
40 load/power supply
41 sensor
42 controller
43 switch
44 fuse
45 touch protection element
46 touch protection element
47 touch protection element
48 seal
49 lock
50 row of contact openings
51 contact opening
52 screwdriver/tool
53 locking part
54 Allen key
55 opening
56 pivot element
57 electrically isolating contact cover portion of housing front side
58 electrically isolating contact cover portion of housing front side
59 fixing screw
60 key shaped hole for fixing screw
61 round hole for fixing screw
62 electrically isolating contact cover portion of housing front side of auxiliary support module
63 electrically isolating contact cover portion of housing front side of auxiliary support module
64 mechanical spring
65 engaging hook of locking part

1. A power supply module for rear-side power supply of a power distribution busbar system comprising a number of busbars for distribution of electrical power for busbar components connectable to said busbars,
said rear side power supply module comprising:
at least one clamping block having a number of clamping contacts adapted to clamp electrical conductors to said clamping block;
a number of electrically conductive and touch-protected intermediate bars provided between the at least one clamping block and a number of touch-protected electrical contacts provided at a front side of said power supply module and adapted to establish an electrical connection between the busbars of said power distribution busbar system and the intermediate bars of said power supply module.

2. The power supply module according to claim 1:
wherein the power supply module comprises:
a first clamping block having a number of clamping contacts adapted to clamp electrical conductors to said first clamping block; and
a second clamping block having a number of clamping contacts adapted to clamp electrical conductors to said second clamping block,
wherein the intermediate bars are provided between said first clamping block and said second clamping block to provide electrical connection between the electrical conductors clamped to clamping contacts of the first clamping block and the electrical conductors clamped to the clamping contacts of the second clamping block of said power supply module.

3. The power supply module according to claim 1 wherein the touch-protected front side electrical contact comprises an electrical lyre or U-shaped contact having a base contact portion connecting two opposing leg contact portions of said electrical lyre or U-shaped contact.

4. The power supply module according to claim 3 wherein the base contact portion of the electrical lyre or U-shaped contact is electrically connected to an associated intermediate bar of said power supply module.

5. The power supply module according to claim 3 wherein the two leg contact portions of the electrical lyre or U-shaped contact are touch protected by electrically isolating contact cover portions of an electrically isolating housing front side adapted to cover the associated intermediate bars lying beneath the housing front side.

6. The power supply module according to claim 5 wherein a portion of a busbar of the power distribution busbar system is pluggable between the electrical contact surfaces of the two leg contact portions of the electrical lyre or U-shaped contact to establish an electrical connection between the busbar of the power distribution busbar system and an intermediate bar of said power supply module through said electrical lyre or U-shaped contact.

7. The power supply module according to claim 6 wherein the two leg contact portions of the electrical lyre or U-shaped contact facing each other and encompassing a portion of a busbar of said power distribution busbar system are attracted to each other in response to an electrical overcurrent flowing through the electrical lyre or U-shaped contact and are pressed against the encompassed portion of the busbar to prevent a separation of the busbar from the electrical lyre or U-shaped contact of the power supply module and to prevent the generation of an electrical arc.

8. The power supply module according to claim 1 wherein the busbar of the power distribution system has a U-shaped profile with two opposing busbar sidewalls connected by a busbar base portion of the busbar, wherein a sidewall of said U-shaped busbar is pluggable between the electrical contact surfaces of the two leg contact portions of the respective electrical lyre or U-shaped contact to establish an electrical connection between the U-shaped busbar and the intermediate bar through the electrical lyre or U-shaped contact.

9. The power supply module according to claim 8 wherein the busbar base portion of the U-shaped busbar of said power distribution busbar system comprises contact slots adapted to receive protruding electrical contacts of busbar components pluggable into the contact slots of the busbar base portion of said U-shaped busbar.

10. The power supply module according to claim 1 wherein the at least one clamping block of the power supply module is touch-protected by associated removable or movable touch protection cover elements, wherein the removable or moveable touch protection cover element of the at least one clamping block is secured by a sealing element or by a lock element against unintentional removal of the touch protection cover element by a user.

11. The power supply module according to claim 1 wherein the clamping contacts of the at least one clamping block comprise prism clamp contacts or box terminal contacts or comprise a screw system for cable lugs.

12. The power supply module according to claim 2 wherein the clamping contacts of the second clamping block of said power supply module provide a loop-through functionality to loop the electrical conductors clamped to the clamping contacts of the first clamping block of said power supply module via intermediate conductors to clamping contacts of a clamping block of an extension power supply module provided for rear-side power supply of further busbars of said power distribution system.

13. The power supply module according to claim 1 wherein a busbar board with integrated busbars of the power distribution system is mounted on the power supply module and on an associated auxiliary support module and wherein the power supply module and its associated auxiliary module are used to provide mechanical support to the mounted busbar board and are adapted to provide a mechanical tolerance compensation for manufactured screw holes on the mounting plate of the power supply module and the associated auxiliary support module.

14. The power supply module according to claim 1 wherein the power supply module, an associated extension power supply module and associated auxiliary modules are mounted on a mounting platform of a control cabinet,
wherein the mounting platform of the control cabinet comprises a mounting plate to which the power supply module, the associated extension power supply module and the auxiliary modules are fixed by means of fixing screws or wherein the mounting platform comprises a frame mounted busbar system having supporting bars to which busbar boards are fixed by means of brackets and wherein the power supply module and the extension power supply module are plugged into the rear side of the busbar boards.

15. The power supply module according to claim 1 wherein the busbars of the power distribution busbar system are integrated in a housing of a touch-protected busbar board.

16. The power supply module according to claim 1 wherein the power supply module, the associated extension power supply module and the associated auxiliary modules comprise integrated assembly elements of a locking part used for a tool-free assembly of the touch-protected busbar board on the respective modules.

17. The power supply module according to claim 16 wherein the locking part of the power supply module, of the associated extension power supply module and of the associated auxiliary modules used for a tool-free assembly of the touch-protected busbar board on the respective module is after removal of a touch protection cover element accessible by a tool used for disengaging the engaged locking part integrated at the front side within the respective modules or provided on the rear side of the housing of the touch-protected busbar board from the assembly element for removal of the touch-protected busbar board from the respective modules.

18. The power supply module according to claim 1 wherein an internal electrical current supply path is provided between a clamping contact of the first clamping block of the power supply module and an associated busbar of the power distribution busbar system through an intermediate bar of said power supply module, wherein the power supply module comprises for each internal current supply path a current sensor element adapted to measure an electrical current flowing through the respective current supply path and/or comprises a voltage sensor element adapted to measure a voltage applied to the respective current supply path and/or comprises a fuse element.

19. The power supply module according to claim 18 wherein the internal current supply path of the power supply module comprises a manually operated or controllable switching element for interruption of the respective internal current supply path (CSP) of the power supply module to provide protection, in particular overcurrent protection or overload protection, to loads receiving their power supply through busbar components connected to busbars of the power distribution busbar system, wherein the controllable switching element comprises a semiconductor power switch controlled by an integrated control unit of said power supply module in response to sensor signals generated by sensor elements of the power supply module and/or comprises an electromechanical switching element.

20. The power supply module according to claim 1 wherein a busbar board is mountable to the power supply module manually without using a tool and is removable from the power supply module by means of a manually operated tool adapted to disengage mechanically sprung assembly elements of a locking part integrated and accessible at the front side of the housing of the respective module.

21. The power supply module according to claim 1 wherein the power supply module is turnable along the z axis by 180 degrees on the mounting platform such that its clamping block is facing an external power supply.

22. A control cabinet comprising a mounting platform for mounting at least one power supply module according to claim 1 used for a rear-side power supply of power consuming load devices through busbar components provided at a front side of the control cabinet by a power distribution busbar system of said control cabinet.

23. The control cabinet according to claim 22 wherein the power distribution system comprises a number of busbars used for distribution of AC power or for distribution of DC power among busbar components connected through electrical contacts to the busbars of the power distribution system and/or used for powerline communication between busbar components connected to the busbars of the power distribution system,
wherein a resistive, a capacitive or an inductive power consuming load device is connectable to a busbar component being connected through the electrical contacts, busbars and a current supply path (CSP) of the power supply module to the power distribution system of said control cabinet to receive an electrical power supply via said busbar component and/or
wherein a power generation device is connectable to a busbar component being connected through the electrical contacts, busbars and a current supply path (CSP) of the power supply module to the power distribution system of said control cabinet to provide electrical power for the power distribution system of said control cabinet.
